(19) United States
(12) Patent Application Publication
(10) Pub. No.: US 2017/0245567 A1
(43) Pub. Date: Aug. 31, 2017

(54) ARTICLES OF CLOTHING WITH INTEGRATED PORTABLE MOBILE ELECTRONIC DEVICE ENHANCEMENTS

(71) Applicant: INCIPIO, LLC, IRVINE, CA (US)

(72) Inventors: Andy Fathollahi, Corona Del Mar, CA (US); Ahmed Abdallah, Mission Viejo, CA (US); Jordan Philip Raths, Sunset Beach, CA (US)

(73) Assignee: INCIPIO, LLC, Irvine, CA (US)

(21) Appl. No.: 15/397,672

(22) Filed: Jan. 3, 2017

Related U.S. Application Data
(60) Provisional application No. 62/275,763, filed on Jan. 6, 2016.

(51) Int. Cl. A41D 27/20; H02J 7/00; A41D 1/00; A41D 3/00; A41D 27/04

(52) U.S. Cl. CPC A41D 27/205; A41D 3/00; A41D 27/201; A41D 27/04; A41D 1/002; H02J 7/0045; H02J 7/0027; A41D 2300/322; A41D 2300/32; A41D 2300/324

(57) ABSTRACT

Articles of clothing having integrated portable electronic device enhancement features are disclosed. The articles of clothing include a plurality of pockets configured to securely store electronic devices and accessories therefore and cable routing to provide seamless integration and connectivity between those devices while allowing user accessibility. A flexible rechargeable battery is also provided and configured to integrate into one or more pockets and connect to other electronic devices through passages positioned within the article of clothing. A wireless Bluetooth media controller is uniquely integrated into the article of clothing to facilitate external wireless control of devices contained within the article of clothing. The articles of clothing are configured to allow liners to be fastened there-within yet maintain usability of cable routing features in the article of clothing and user accessibility to mobile device compartments.

### INCORPORATION BY REFERENCE TO RELATED APPLICATIONS

This application claims the benefit of priority under 35 U.S.C. §119(e) to U.S. Provisional Application No. 62/275,763, filed Jan. 6, 2016 and titled “ARTICLES OF CLOTHING WITH INTEGRATED PORTABLE MOBILE ELECTRONIC DEVICE ENHANCEMENTS”. The above application is hereby incorporated herein by reference in its entirety and is to be considered as a part of this specification.

### BACKGROUND INFORMATION

Field of the Invention

This patent application relates to articles of clothing such as jackets that integrate and are capable of enhancing the mobile electronic device experience.

### Background Information

These days, people use portable mobile electronic devices, such as smartphones, tablet computers, laptops, cameras, mp3 players, gaming devices, portable speakers, drones, activity monitors, health monitors, and wired and wireless earphones more and more frequently while traveling, commuting, and engaging in various indoor and outdoor activities, such as shopping, biking, exercising, snowboarding, skiing, and other sports and activities. The applicants here have recognized that conventional clothing and apparel do not provide such on-the-go users with features that facilitate the seamless integration of such mobile electronic devices or are conducive to storage and use of such mobile electronic devices alone or in combination with other devices and accessories therefore.

Accordingly, disclosed herein are articles of clothing with integrated portable electronic device enhancements that are capable of facilitating the seamless integration of such mobile electronic devices and accessories therefore.

### SUMMARY

The subject matter of this disclosure is generally directed to articles of clothing having enhanced mobile electronic integration features. The particular implementations are directed to jackets or outwear that facilitate an improved user experience by creating uniquely designed compartments and cable routing features that are capable of integrating mobile devices and accessories to facilitate on-the-go use and storage of such devices. Various aspects are described herein.

In one aspect, the jacket includes pockets or compartments configured to securely store mobile electronic devices. The compartments include channels and external structures that facilitate the routing of control, charging and/or audio cables to the user and to the user's other mobile electronic accessories and devices.

In one aspect, the jacket is comprised of a front right panel, a front left panel, and a back panel. The panels, hood, and sleeves of the jacket may be unitarily formed or bonded together, such as by stitching, ultrasonic seaming, chemical adhesive bonding, thermal bonding, laser enhanced bonding, and removable bonding (e.g., snaps, hook-and-loop fasteners, or zippers), and stitched elements may include single or multiple lines of stitching, bar tack stitches for improved strength, and taped or sealed seams for additional wind-proofing and waterproofing. The jacket may include an outer zipper or other fastener (e.g., a hook-and-loop fastener, snaps, buttons, hooks, clasps, or magnetic closure) configured to enable a user to removably secure the front right panel to the front left panel around a wearer. A zipper is formed of a first track that is removably connected to a second track by a slider. Each track may include an attachment portion and a toothed portion, where the attachment portion is bonded to the associated jacket material and the toothed portion of the first track is engaged to the tooth portion of the second track by the slider.

A removable liner can be fastened to the inside of the jacket, providing additional protection from the elements. Removable liner can be worn as a fleece or light coat when separated from jacket. When worn separate from jacket, liner is secured by a liner zipper that runs vertically along the front of the liner.

A flexible battery bank is configured and dimensioned to be stored in a correspondingly dimensioned flexible battery bank pocket and connected to electronic devices stored in jacket pockets. Flexible battery bank includes one or more battery cells, a battery control circuit, an input port (e.g., micro-USB) for charging the battery cells, an output port (e.g., USB) for providing power to electronic devices, a button and a charge indicator all contained in a flexible housing. Flexible housing includes gaps or hinges between the battery cells to allow the flexible battery bank to adjust and conform. Flexible housing also provides some cushioning and water protection to the battery cells and electronics.

The jacket may be comprised of an internal lining and an external lining. The internal lining and external lining may be constructed of natural (e.g., silk, leather, wool, wood pulp, or canvas) or synthetic (e.g., nylon, acrylic, polyester, polyamides, polypropylene, polyurethane (PE), or polytetrafluoroethylene (PTFE)) materials or a combination thereof (e.g., castor oil treated polyurethane or durable water repellent (DWR) treated canvas). The external lining may preferably be constructed from a waterproof or water resistant, and/or windproof or wind resistant material. The internal lining may preferably be constructed from a breathable or moisture-wicking material.

A plurality of pockets may be formed in or on either the internal lining or external lining. The pockets may be adapted and dimensioned to hold specific electronic devices (e.g., mobile phones, tablet computers, or action cameras), device accessories (e.g., headphones, cables, battery banks, or memory cards), or articles of clothing (e.g., gloves, beanies, hoods, glasses, or goggles). Pockets can be left open or closed/secured in a variety of ways, including zippers, buttons, snaps, magnets, hook-and-loop fasteners, straps, or simply relying on gravity or a strap to retain items. Some of the pockets adapted and dimensioned to hold electronic devices or accessories may include eyelets or grommets to allow cables to exit the pocket without reducing protection from the elements or allowing the device or accessory to fall out.

Some pockets may include multiple independent cavities, each with independent entry points. Pockets can be formed in a variety of ways, including bonding an interior pocket bag to an opening, bonding an additional pocket layer of material to the internal or external lining, forming a cavity between the pocket layer and the internal or external lining or forming a user openable and closable passage from the exterior of the jacket through to the interior of the jacket.

In addition to the pocket eyelets described above, the jacket includes additional cable routing elements including cord tunnels for convenient and secure cable routing, cord passages, and cord straps.

Cord tunnels include an attachment portion connected to a hollow tunnel with an access cutout, adapted and dimensioned to allow a cable to be intentionally inserted into the hollow tunnel, where it will remain secured until intentionally removed. The cord tunnels route headphone and power cables conveniently within the jacket.

Cable or cord passages can be formed through the panels, in the hood, or along the sleeves. Cord passage may pass through internal and external lining, allowing a headphone cable and/or power cord to pass along the interior of the jacket from an external device or accessory. For example, cord passages may include jack storage at the sleeves, which routes an audio or power cord from an electronic device in a user's hand along the sleeve to the interior of the jacket. Another example of a cord passage includes hood passage, which routes headphone cables (or other cords) to convenient locations near a user's neck or ear.

Cord straps can secure a cable or jack in a convenient location, such as collar headphone loop for holding an earbud near the collar or sleeve headphone loops at the front of each sleeve to secure a headphone cable that is routed through sleeve cable passage or elastic cord strap for securing a rolled or folded cable in a pocket to keep the cable from tangling each time a user reaches into the pocket.

First track s of a liner zipper can couple to second track of a liner zipper; however, in liners compatible with the interface zipper system, first track of the liner zipper are additionally configured to couple to first track of the jacket attachment zipper and second track of the liner zipper is additionally configured to couple with second track of the jacket attachment zipper, connecting a compatible liner to a jacket.

Compatible liners and jackets can be mixed and matched, allowing users to adjust elements of an outfit according to weather and style without requiring entire new outfits. Jackets and liners can also each be used independently.

Each of the foregoing various aspects, together with those set forth in the claims, described in the drawings and written description provided or otherwise disclosed in this patent document may be combined to form claims for a device, apparatus, system, methods of manufacture and/or use in any way disclosed herein without limitation.

### BRIEF DESCRIPTION OF THE DRAWINGS

These and other features, aspects and advantages, as to its structure, operation, and manufacture are described below with reference to the drawings, in which like reference numerals refer to like parts throughout. Though components in the figures are often illustrated to scale, emphasis of these drawings is placed upon illustrating the principles of the various inventive aspects disclosed herein. Moreover, all illustrations are intended to convey concepts, where relative sizes, shapes and other detailed attributes may be illustrated schematically rather than literally or precisely.

FIGS. 1A-1J are various perspective and detailed views of a first embodiment of a technology (“tech”) jacket.

FIG. 1A is a first external front view of a first embodiment of the tech jacket with all pockets closed.

FIG. 1B is a second external front view of the first embodiment of the tech jacket detailing the internals of some pockets.

FIGS. 1C and 1D are detailed views of a lower right external pocket from the first embodiment of the tech jacket.

FIG. 1E is a third external front view of the first embodiment of the tech jacket detailing the media control.

FIG. 1F is a first internal plan view of the first embodiment of the tech jacket detailing the construction of the pockets.

FIG. 1G is a second internal plan view of the first embodiment of the tech jacket detailing some of the cable routing elements.

FIG. 1H is a detailed view of an upper left internal pocket from the first embodiment of the tech jacket.

FIG. 1I is an external rear view of the first embodiment of the tech jacket.

FIG. 1J is a compilation of detailed views of the hood drawcord mechanism and the sleeve nylon strap of the first embodiment of the tech jacket.

FIGS. 2A-2G are various perspective and detailed views of a second embodiment of a tech jacket.

FIG. 2A is a first external front view of a second embodiment of the tech jacket with all pockets closed.

FIG. 2B is a detailed view of an upper right external pocket from the second embodiment of the tech jacket.

FIG. 2C is a detailed view of a lower right external pocket from the second embodiment of the tech jacket.

FIG. 2D is a second external front view of the second embodiment of the tech jacket detailing some elements of the collar.

FIG. 2E is an internal plan view of the second embodiment of the tech jacket.

FIG. 2F is a detailed view of an upper left internal pocket from the second embodiment of the tech jacket.

FIG. 2G is an external rear view of the second embodiment of the tech jacket.

FIGS. 3A-3E are various perspective and detailed views of a third embodiment of a tech jacket.

FIG. 3A is a first external front view of a third embodiment of the tech jacket.

FIG. 3B is a detailed view of an upper left external pocket in a closed position from the third embodiment of the tech jacket.

FIG. 3C is a detailed view of an upper left external pocket in an open position from the third embodiment of the tech jacket.

FIG. 3D is an external rear view of the third embodiment of the tech jacket.

FIG. 3E is an internal plan view of the third embodiment of the tech jacket.

FIGS. 4A-4H are various perspective and detailed views of a fourth embodiment of a tech jacket.

FIG. 4A is a first external front view of a fourth embodiment of the tech jacket.

FIG. 4B is a second external front view of a fourth embodiment of the tech jacket detailing the upper pocket bags and hidden magnets.

FIG. 4C is a third external front view of a fourth embodiment of the tech jacket, detailing the sleeve cable passages.

FIG. 4D is a fourth external front view of a fourth embodiment of the tech jacket, detailing the media control.

FIG. 4E is a compilation of detailed views of the chest pocket and the packable hood of the fourth embodiment of the tech jacket.

FIG. 4F is an external rear view of the fourth embodiment of the tech jacket, detailing the packable hood.

FIG. 4G is a first internal plan view of the fourth embodiment of the tech jacket, detailing the elements of the pockets.

FIG. 4H is a second internal plan view of the fourth embodiment of the tech jacket detailing some of the cable routing elements.

FIG. 5 is a perspective view of the flexible battery bank removed from a flexible battery bank pocket.

FIG. 6 is a compilation of side and exploded perspective views of the internal components of the media controller of FIGS. 1E and 4D.

FIG. 7 is a compilation of views of the cord or cable tunnels configured for routing cables in the jacket.

FIGS. 8A and 8B is a compilation of outer shells.

FIG. 9 is a compilation of liners that may be connected via an interface zipper system to an outer shell.

### DETAILED DESCRIPTION OF THE EMBODIMENTS

Disclosed herein are article of clothing that includes pockets configured to securely store modern mobile electronic devices and accessories while providing easy access and integrated cable routing to facilitate connectivity and charging of the devices. The embodiments disclosed herein are described in the context of a jacket of the type that may be used in outdoor activities. As used in this document, the term jacket may be considered to include a jacket, a coat, a parka, a blazer, a windbreaker, a sweater, a sweatshirt, a hoodie, or any other garment worn over the upper body. However, it should be understood that the teachings herein may be applied to other articles of clothing. Indeed, it is contemplated that the teachings herein are applicable to pants, hoods, helmets, hats, gloves, shirts, sweaters/sweatshirts, vests, swimsuits, wetsuits, and other apparel items.

As illustrated in the foregoing drawings, the jacket 1000 is configured to fit a wearer so as to extend generally from the hips to the neck (additionally including the head when a hood is worn) and includes a body portion, a hood 1400, and sleeves 1500. The body portion is comprised of a front right panel 1100, a front left panel 1200, a back panel 1300. Some or all of the panels may be and additional panels may be included to improve fit, fashion, or performance. For example, that the panels may be split into upper and lower sub-panels, or may include additional panels or sub panels at the shoulder or around the upper or lower extremities of the arm. The panels (e.g., 1100, 1200, 1300), hood 1400, and sleeve 1500 elements of jacket 1000 may be unitarily formed or bonded or attached to one another, such as by stitching, ultrasonic seaming, chemical adhesive bonding, thermal bonding, laser enhanced bonding, and removable bonding (e.g., snaps, hook-and-loop fasteners, or zippers), and stitched elements may include single or multiple lines of stitching, bar tack stitches for improved strength, and taped or sealed seams for additional wind-proofing and waterproofing. The jacket 1000 may include an outer zipper 1004 or other fastener (e.g., as a hook-and-loop fastener, snaps, buttons, hooks, clasps, or magnetic closure) configured to enable a user to removably secure the front right panel 1100 to the front left panel 1200 around a wearer. A zipper is formed of a first track that is removably connected to a second track by a slider. Each track may include an attachment portion and a toothed portion, where the attachment portion is bonded to the associated jacket material and the toothed portion of the first track is configured to engage to the tooth portion of the second track by the slider.

A removable liner 200 can be fastened to the inside of the jacket 1000, providing additional layer of protection or insulation to the user. Removable liner 200 is configured to be capable of being be worn independently as a fleece or light coat when separated from jacket 1000. When worn separate from jacket 1000, liner 200 is secured by a liner zipper 209 that runs vertically along the front of the liner 200.

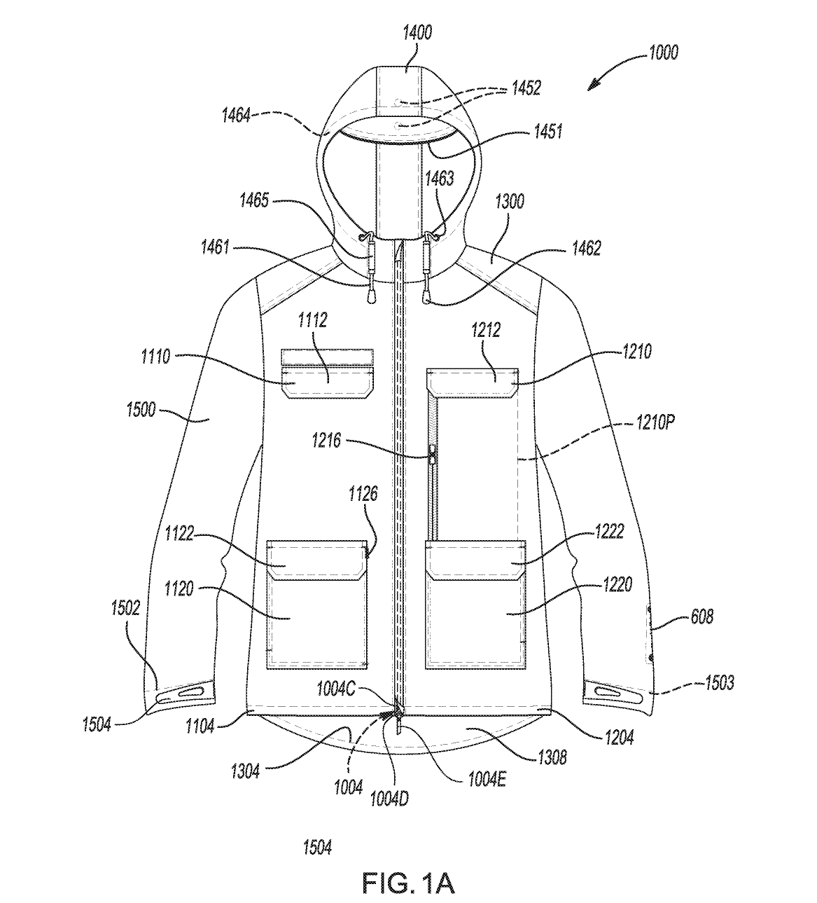

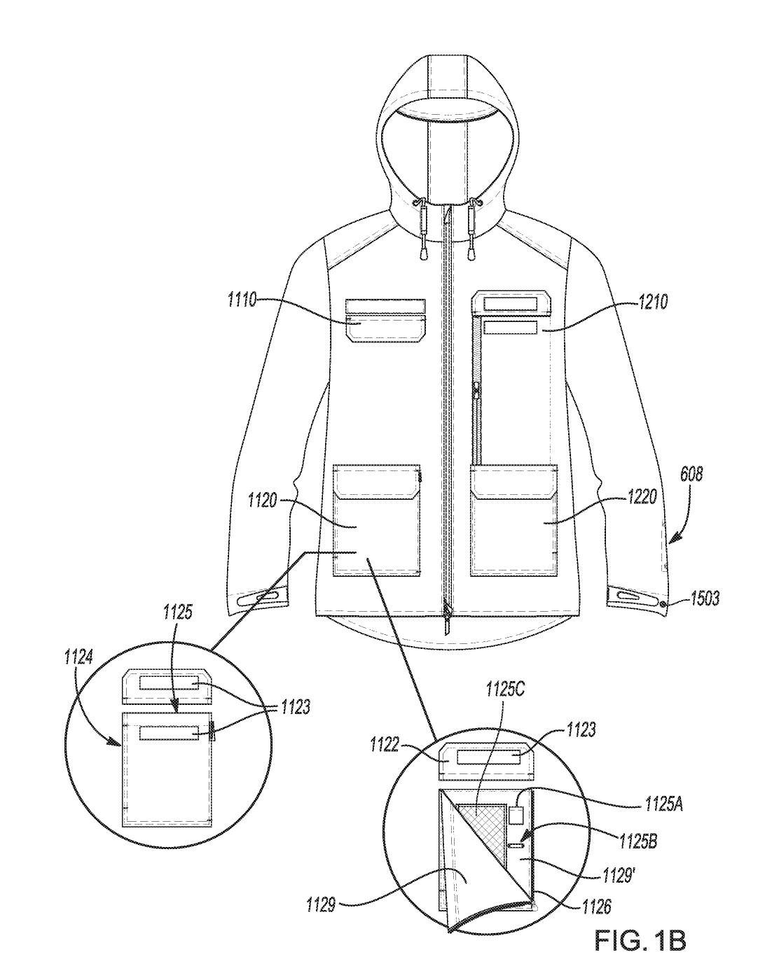

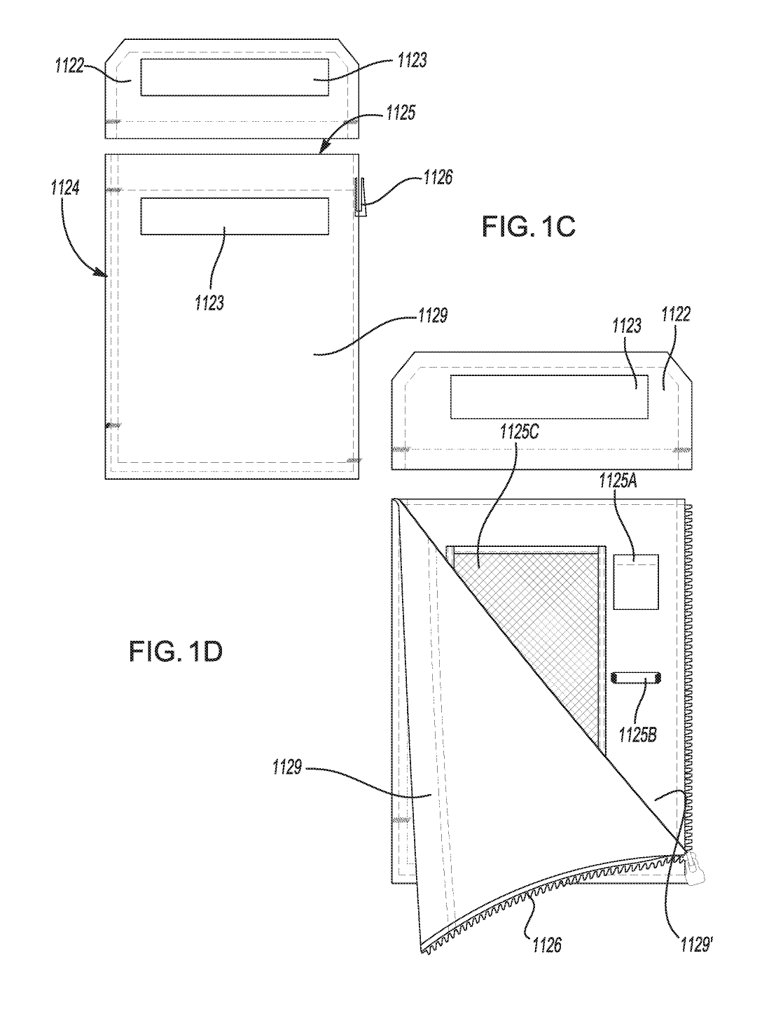

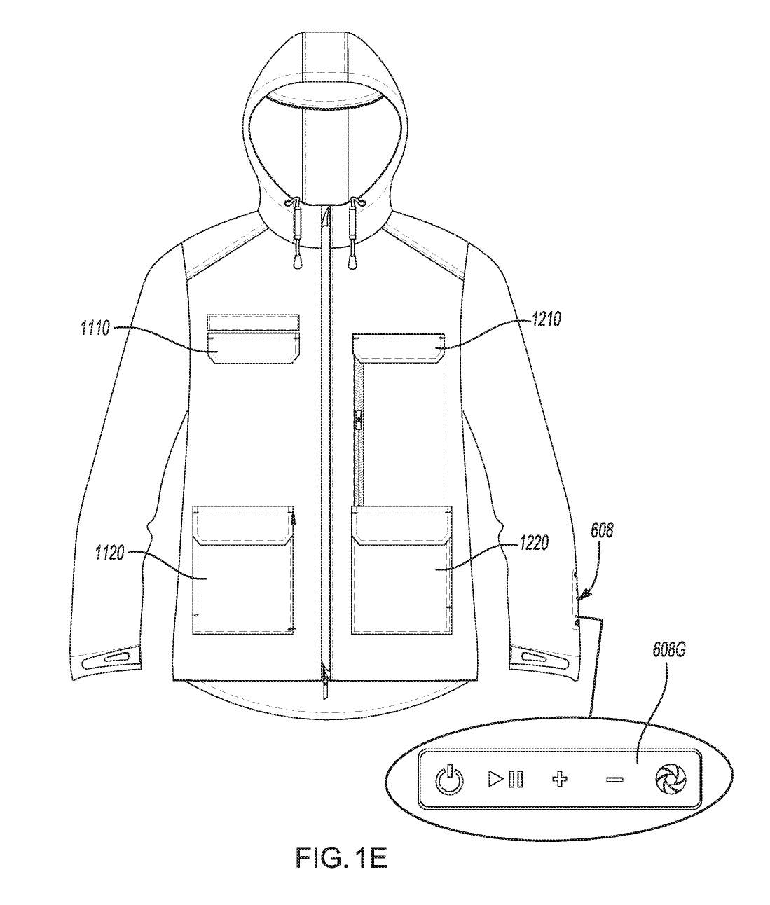

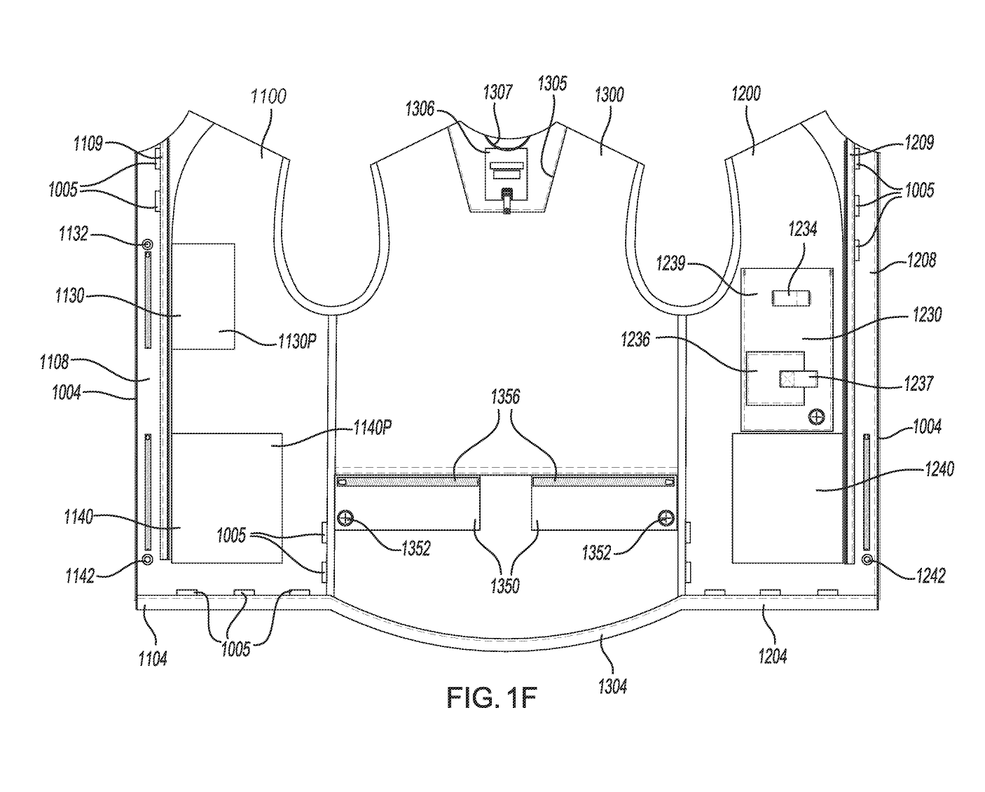

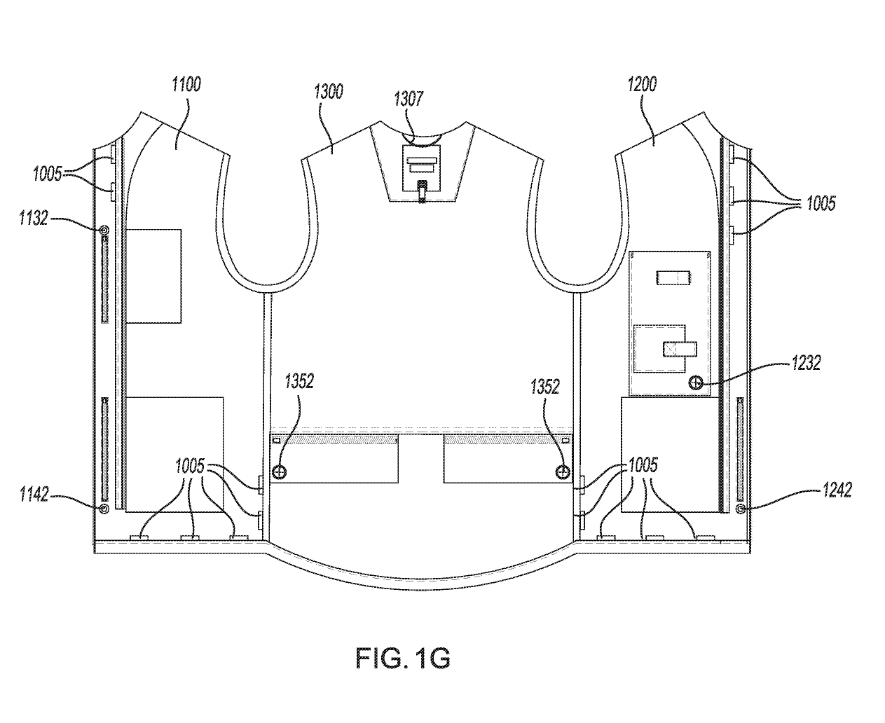

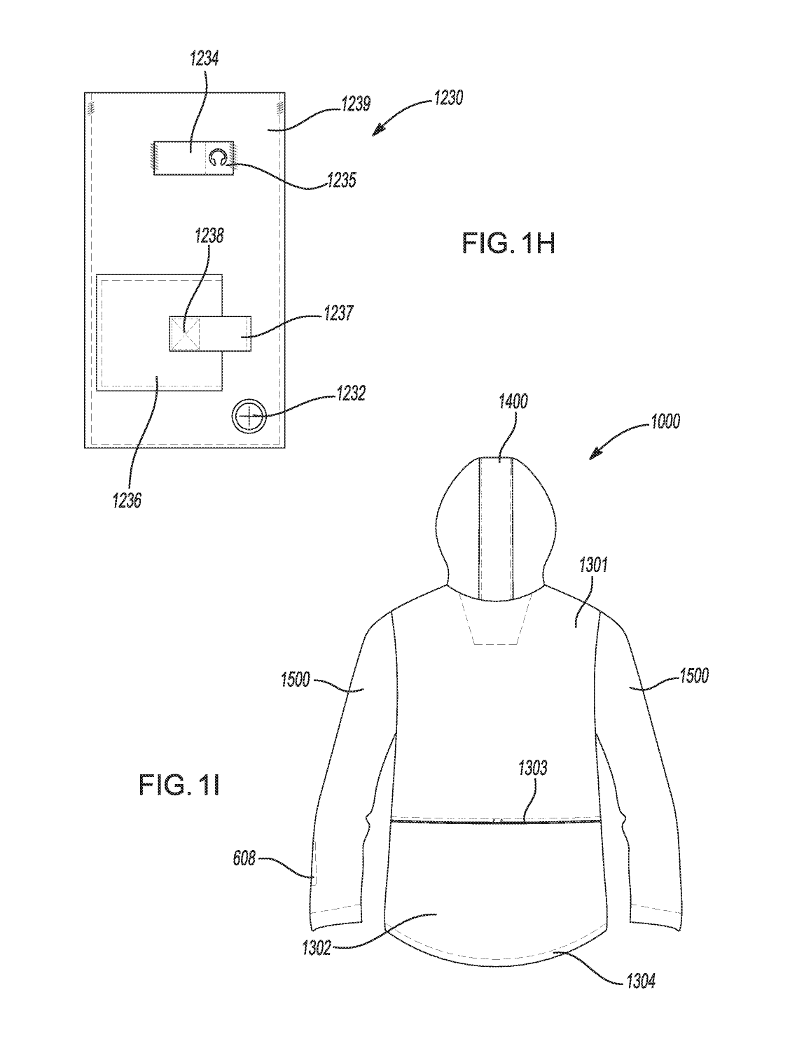

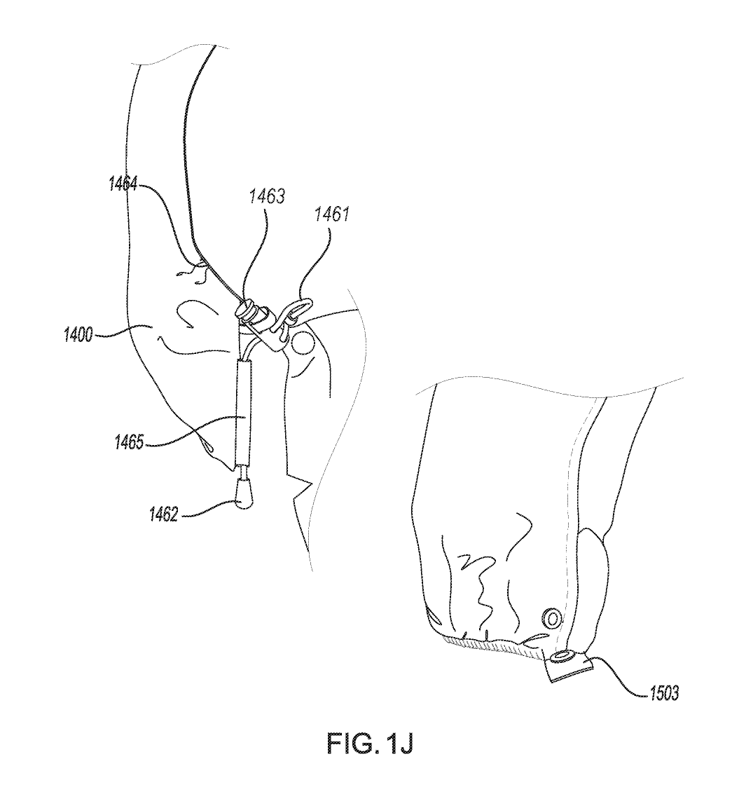

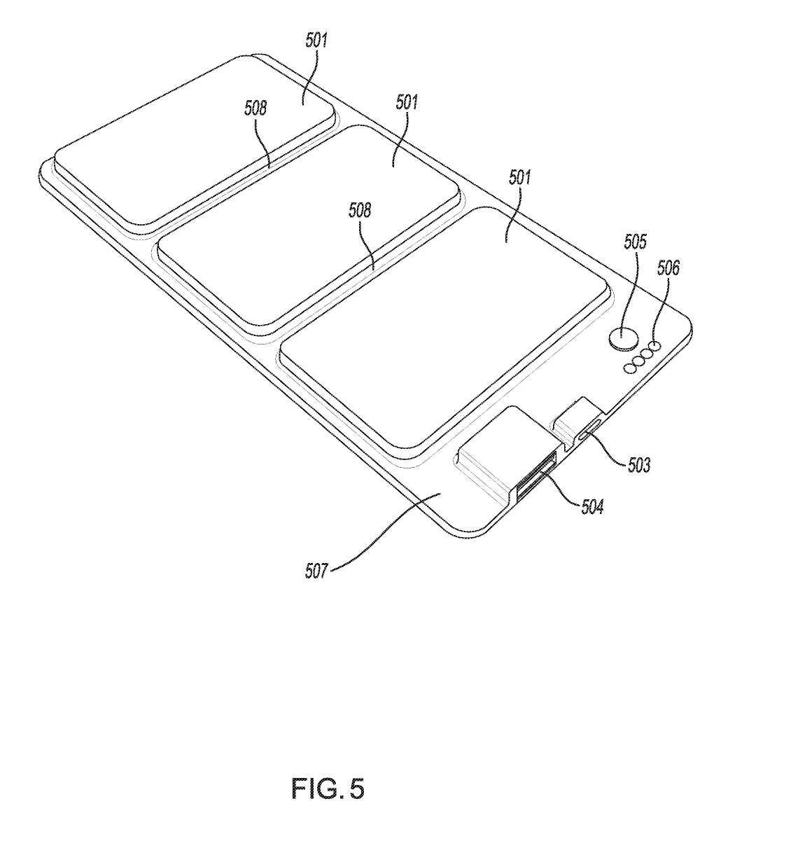

A flexible battery bank 500 (FIG. 5) is configured and dimensioned to be securely stored in flexible battery bank pockets 1350 (FIG. 1F) and connected to electronic devices stored in jacket 1000 pockets via a cabling channels and routing elements as described in more detail below. Flexible battery bank 500 includes one or more battery cells 501, a battery control circuit 502, an input port 503 (e.g., micro-USB) for charging the battery cells 501, an output port 504 (e.g., USB) for providing power to electronic devices, a button 505 and a charge indicator 506 all contained in a flexible housing 507. Flexible housing 507 includes structural partition or gaps 508 on one side between the battery cells 501 to allow the flexible battery bank to hinge there along so as to be capable of adjusting and conforming to the user's body. The opposing side of the housing 507 includes in a first implementation, a smooth outer surface that extends contiguously on the exterior to provide a uniform surface facing the user's body. The flexible housing 507 may also be constructed to provide additional cushioning and sealed so as to be waterproof or water resistant to better protect the rechargeable batteries housed therein.

The jacket 1000 may be comprised of an internal lining 1001 and an external lining 1003. The internal lining 1001 and external lining 1003 may be constructed of natural (e.g., silk, leather, wool, or canvas) or synthetic (e.g., nylon, acrylic, polyurethane (PE), or polytetrafluoroethylene (PTFE)) materials or a combination thereof (e.g., castor oil treated polyurethane or durable water repellent (DWR) treated canvas). External lining 1003 may preferably be constructed from a waterproof or water resistant, and/or windproof or wind resistant material. Internal lining 1001 may preferably be constructed from a breathable or moisture-wicking material. An insulation layer 1002 (not shown) may be sandwiched between internal lining 1001 and external lining 1003. The insulation layer 1002 may be formed of synthetic (e.g., polyester) or natural materials (e.g., felt, wool, down) or a combination thereof, and the insulation may be in a batted or loose form. Loose insulations may be incorporated using baffled panel segments connecting the internal lining 1001 and external lining 1003 to secure and better position the insulation in the desired location.

The interior of jacket 1000 includes a zipper turnback 1205, 1105 on the interior of each of the front panels 1200, 1100. Outer zipper 1004 tracks may be bonded at an outer edge of each of the zipper turnbacks 1105, 1205. An attachment zipper 1009 track can be bonded interior to the outer zipper on each front panel 1100, 1200. A vertical access strip 1108, 1208 is provided between the outer zipper 1004 and the attachment zipper 1009 on each front panel 1100, 1200. Attachment zipper 1009 can also connect to liner zipper 209 for attaching and detaching the removable liner 200 from the jacket 1000. A liner slider of the liner zipper 209 can engage a first track 209A of the liner zipper 209 to either a second track 209B of the liner zipper 209 or to a first track 1009A of the attachment zipper 1009. An attachment slider of the attachment zipper 1009 is provided to engage a second track 209B of the liner zipper 209 to a second track 1009B of the attachment zipper 1009. When each track of the liner zipper 209 is paired with a track of the attachment zipper 1009, the liner 200 is connected to the jacket 1000. Additional fasteners, such as buttons or snaps in the sleeves 1500 and/or hood 1400, may be additionally used to secure other parts of the liner 200 to the jacket 1000.

A plurality of pockets (e.g., 1110, 1220, 1350) are formed in or on the internal lining 1001 and/or external lining 1003. The pockets may be adapted and dimensioned to securely store and hold specific electronic devices (e.g., mobile phones, tablet computers, or action cameras), device accessories (e.g., headphones, cables, battery banks, or memory cards), or articles of clothing (e.g., gloves, beanies, hoods, glasses, or goggles). Pockets can be left open or closed/secured in a variety of ways, including zippers, buttons, snaps, magnets, hook-and-loop fasteners, straps, or simply relying on gravity or a strap to retain items. Some of the pockets adapted and dimensioned to hold electronic devices or accessories may include eyelets or grommets to allow cables to be routed into and out of the pocket to allow integrated connectivity while maintaining a secure storage of the device within the compartment the.

Some pockets or compartments may include multiple cavities (e.g., lower right external pocket 1120) separated from one another and each with dedicated or separate entry points. Pockets may be formed using a variety of construction methods, including bonding an interior pocket bag to an opening (e.g., upper right external pocket 1110 and lower left internal pocket 1290), bonding an additional pocket layer of material to the internal or external lining 1001, 1003, forming a cavity between the pocket layer and the internal or external lining (e.g., lower left external pocket 1220 and flexible battery bank pocket 1350), or forming a user openable and closable passage from the exterior of the jacket through to the interior of the jacket (e.g. Upper Left Pass-through Pocket 1210B).

In addition to the pocket eyelets described above, jacket 1000, as previously noted, includes additional cable routing elements such as cord tunnels 1005 cord passages 1006, and cord straps 1007 to facilitate convenient and secure cable routing that is accessible even when a liner is zipped into the outer jacket.

Cord tunnels 1005 include an attachment portion 1005A connected to a hollow tunnel portion 1005B with an access port or channel 1005C, adapted and dimensioned to allow a cable to be inserted into the hollow tunnel portion 1005B, where it will remain secured until actively removed. The cord tunnels 1005 are configured to route headphone and power cables conveniently within the jacket including from integrated pockets or compartment that secure connected devices.

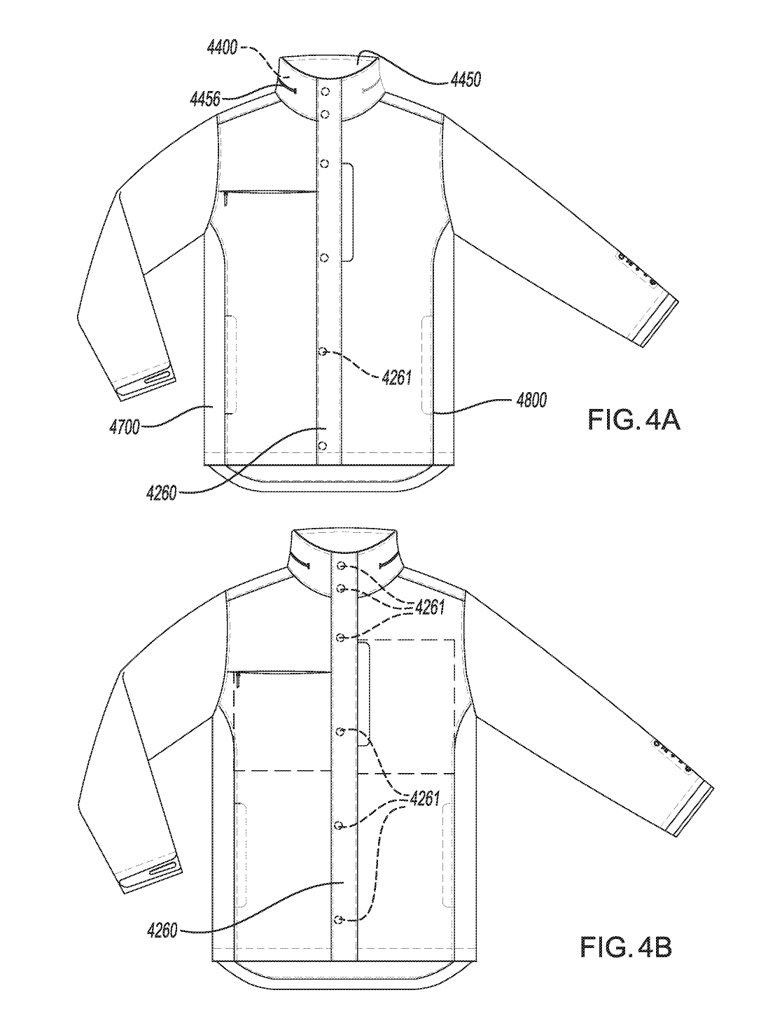

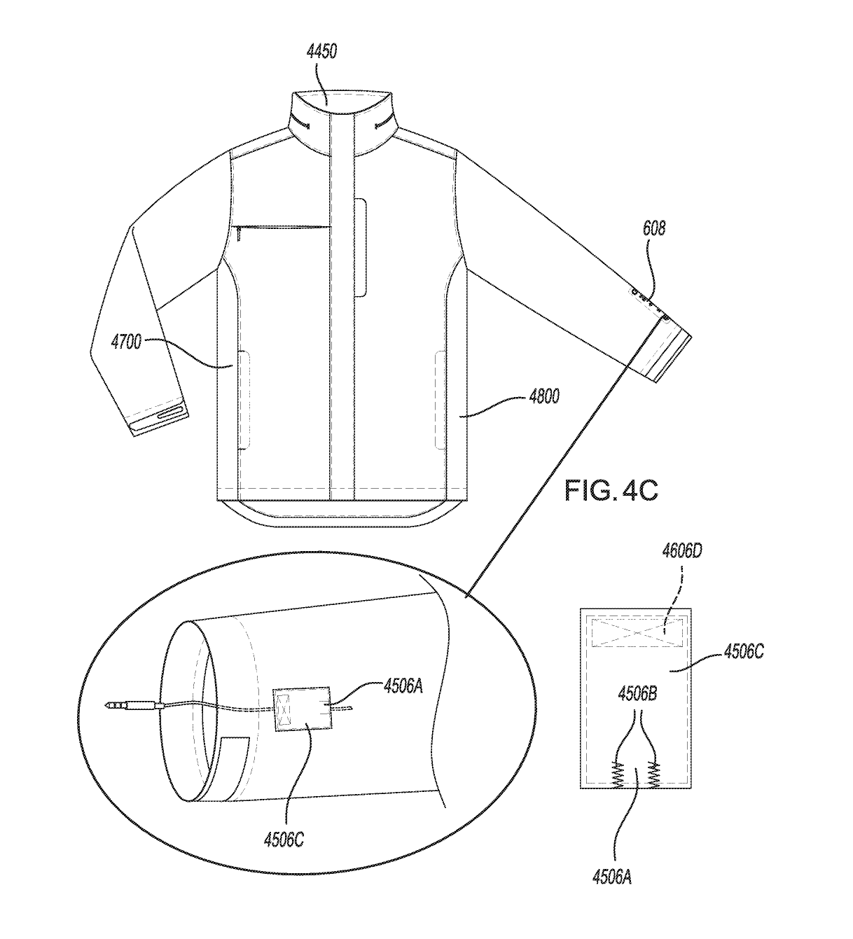

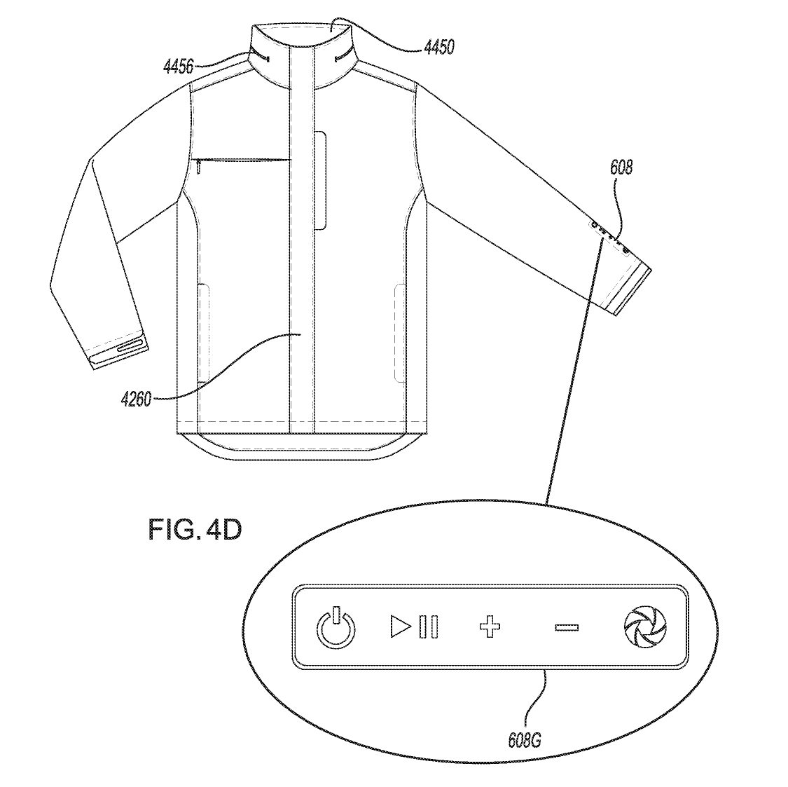

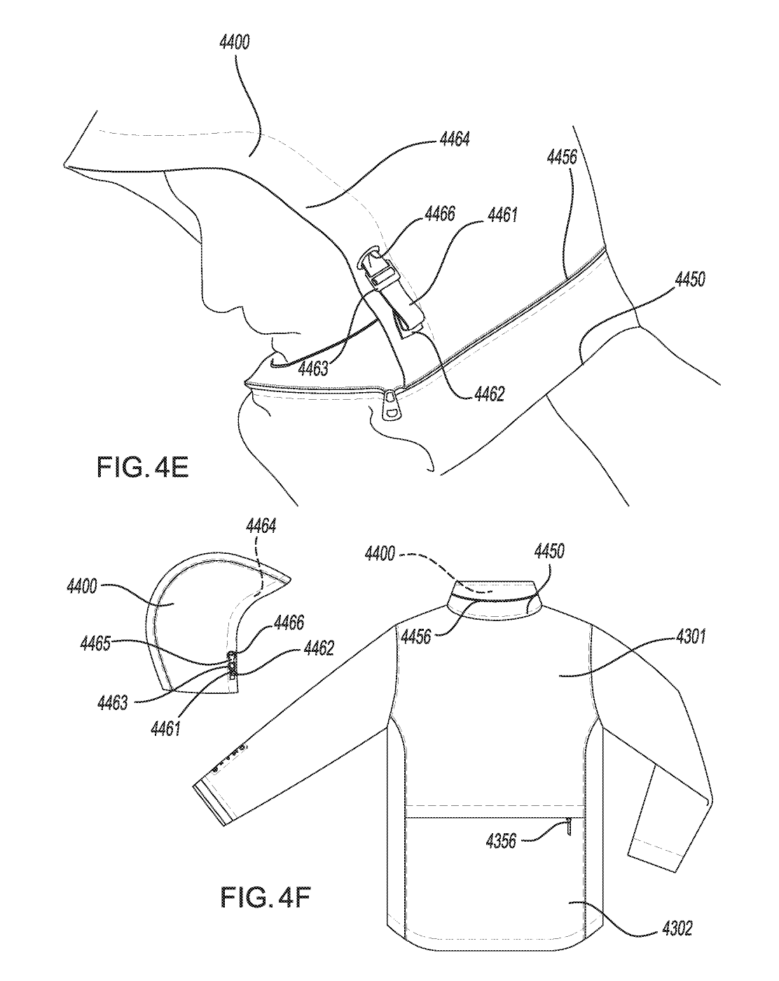

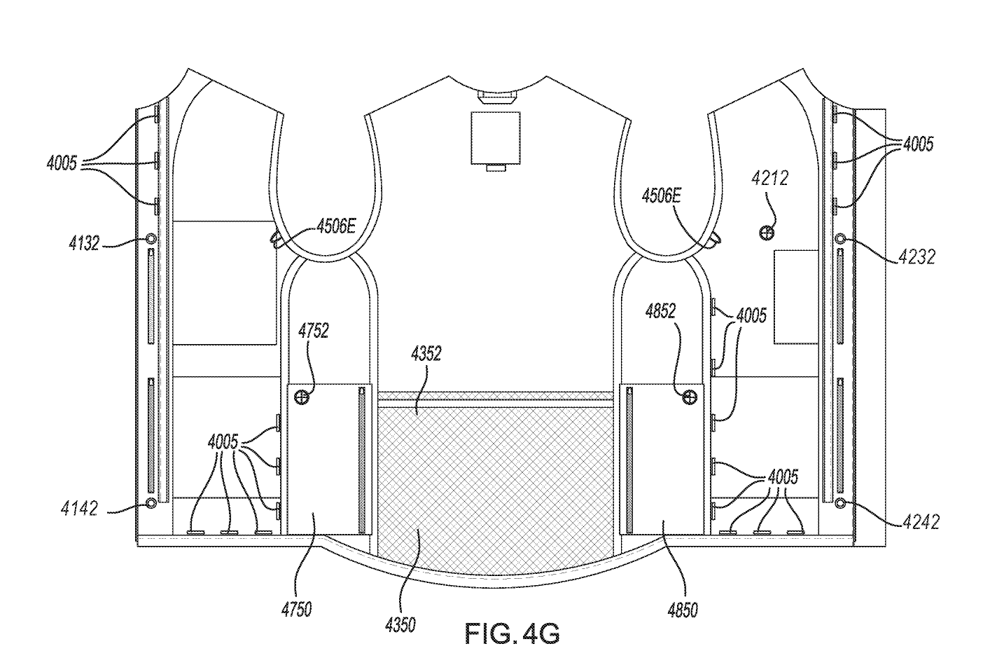

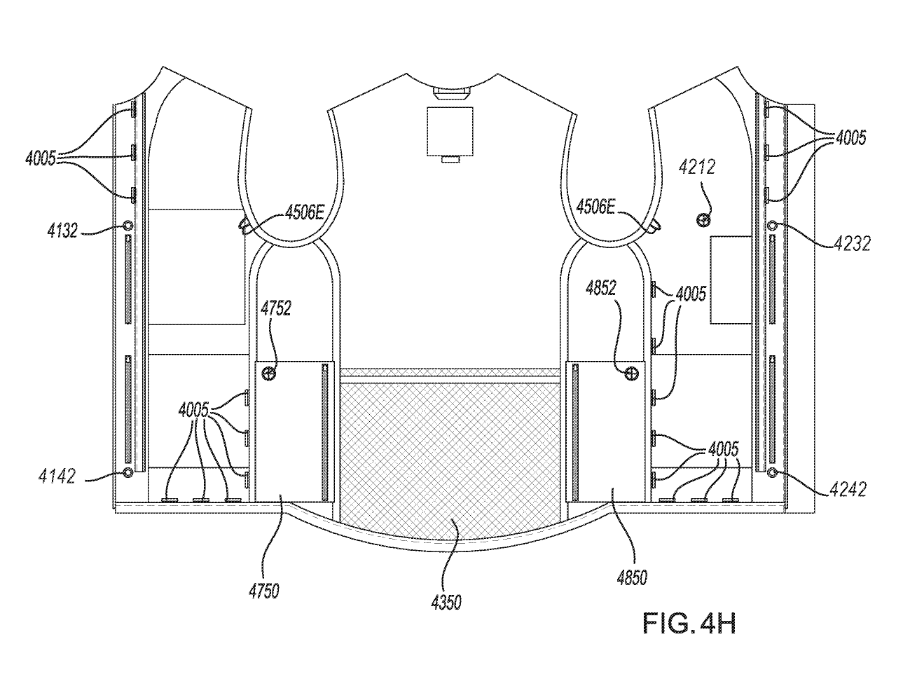

Cable or cord passages 1006 are formed through the panels 1100, 1200, 1300, in the hood 1400, or along the sleeves 1500. Cord passage 1006 may pass through internal and external lining 1001, 1003, allowing a headphone cable and/or power cord to pass along the interior of the jacket 1000 from an external device or accessory. For example, cord passages 1006 may include cable sleeve passage or jack storage 4506 at the sleeves (see FIG. 4C), which routes an audio or power cord from an electronic device in a user's hand along the sleeve to the interior of the jacket. Another example of a cord passage includes hood passage 1406, which routes headphone cables (or other cords) to convenient locations near a user's neck or ear.

Cord straps may be provided to secure a cable or jack in a convenient location, such as collar headphone loop 1457 for holding an earbud or headphone near the collar 1450 or sleeve headphone loops 1507 at the front of each sleeve 1500 to secure a headphone cable that is routed through sleeve cable passage 4506 or elastic cord strap 1127 for securing a rolled or folded cable in a pocket to manage the cable and keep it from tangling when the user reaches into the pocket.

As illustrated in the foregoing drawings, and with specific reference to FIGS. 1A-1J, an embodiment of a jacket 1000 is illustrated. As previously noted, the body of jacket 1000 is comprised of a front right panel 1100, a front left panel 1200, and a back panel 1300. Jacket 1000 includes hood 1400 and sleeves 1500 bonded to the body.

Each panel may be independently formed by bonding an internal lining 1001 to an external lining 1003 and connecting the various panels together as previously discussed.

Front right panel 1100 includes a single-stitched one inch turnback hem 1104 at a lower edge and a single-stitched zipper turnback 1105 along a right edge. Front left panel 1200 includes a single-stitched one inch turnback hem 1204 at a lower edge and a single-stitched zipper turnback 1205 along a left edge. Back panel 1300 includes a single-stitched one inch turnback hem 1304 at a lower edge and a turnback neck panel 1305 at the center of the top edge where a locker loop 1307 and labels 1306 may be bonded.

The left edge of front right panel 1100 is stitched to a right edge of back panel 1300, and the right edge of front left panel 1200 is stitched to a left edge of back panel 1300, opposite front right panel 1100. A top left edge and top right edge (on either side of the turnback neck panel 1305) of the back panel 1300 extends higher than a top edge of the front panels 1100, 1200 and is extended over the shoulder, where it is stitched to the top edges of the front panels 1100, 1200 in front of the shoulder area, leaving openings for the sleeves 1500 to be stitched to the body. The back panel 1300 overlaps and is stitched to the front panels 1100, 1200 slightly in front of the shoulder to reduce tension and improve waterproofing.

Back panel 1300 is split into an upper back panel 1301 and lower back panel 1302 connected by a quarter-inch double-stitched or otherwise bonded back yoke 1303. Rear panel 1300 additionally includes a drop tail 1308, that extends lower than the front panels 1100, 1200 and extends over a portion of a wearer's rear, providing additional insulation and/or waterproofing when a wearer sits in the snow.

As shown in FIGS. 1A-1J, the jacket 1000 includes an outer zipper 1004 or other fastener (e.g., as a hook-and-loop fastener, snaps, buttons, hooks, clasps, or magnetic closure) configured to enable a user to removably secure the front right panel 1100 to the front left panel 1200. Outer zipper 1004 may include a first track 1004A secured along zipper turnback 1105 of front right panel 1100 and removably fastenable to a second track 1004B secured along zipper turnback 1205 of front left panel 1200 by a zipper slider 1004C. Zipper slider 1004C may include a pull tab 1004D on the interior of the jacket and another pull tab 1004D on the exterior of the jacket. Either or both pull tabs 1004D may include a fabric webbing pull 1004E, configured to make the slider easier to hold while cold or wearing gloves. When the jacket is zipped up, the zipper (or fastener) 1004 may be covered beneath a flap of material configured to protect the interior from wind or water. The flap may also include a snap, hook-and-loop, or magnetic fastener to maintain the flap in position.

Each of the foregoing stitches is a double needle thread stitch with a quarter inch between the stitch lines to improve strength. The hood 1400 is stitched to an opening formed at the top of panels 1100, 1200, 1300. Most of the stitching is externally visible along the external lining 1003, but a half inch binding tape covers the seams along the internal lining 1001. The sleeves may be internally stitched.

Jacket 1000 includes a flexible hood 1400, which is adapted and dimensioned to cover a wearer's head when the hood is flipped up, but can hang loosely behind a user's neck when not in use. Hood 1400 is constructed of three (3) single-layer hood panels stitched to each other and jointly bonded to the top edge of the panels 1100, 1200, 1300, leaving a hole for a wearer's neck and head. Hood 1400 may include internal lining 1001 and external lining 1003 to provide additional protection or only single layer external lining 1003 without any internal lining 1001 or insulation 1002 to make the hood lightweight. First zipper track 1004A is additionally secured to the lower right edge of hood 1400 at the top of front right panel 1100 and second zipper track 1004B is additionally secured to the lower left edge of hood 1400 at the top of front left panel 1200, and zipper slider 1004C is configured to zip up the tracks 1004A, 1004B to fully or partially cover a wearer's neck, chin, or face.

For additional protection from the rain, snow, or sun, the hood 1400 includes a rain bill 1451, stitched to hood 1400 as shown. Rain bill 1451 may be foldably retracted inside and/or outside of hood 1400 and secured in place by the attraction between a hidden magnet 1452A in rain bill 1451 and a corresponding hidden magnet 1452B in hood 1400.

Hood 1400 can be tightened around a wearer's face by pulling on elastic drawcord 1461, which runs around the brim of hood 1400 in a drawcord tunnel 1464 and emerges from drawcord eyelets 1466. Drawcord tunnel 1464 may be formed as a 1″ turnback hem with drawcord 1461 captured in the loop of fabric. The drawcord 1461 runs through drawcord toggle springs 1463, which are attached to the hood 1400 and configured to adjustably maintain drawcord 1461 at desired lengths, after emerging from eyelets 1463 on either end of the drawcord tunnel 1464 and before hanging through 2.5″ drawcord guides 1465. Drawcord toggle springs 1463 maintain the drawcord 1461—and therefore the hood 1400—in a set position until intentionally pinched and adjusted by a wearer. Each end of drawcord 1461 ends in plastic stoppers 1462 that may be too wide to fit through drawcord guide 1465 or drawcord toggle spring 1463. One or more hood loops or hood straps (not shown) may be bonded to the inside of hood 1400 to maintain earbuds in place when the earbuds are not in use. One side of hood strap 1407 may, for example, be bonded to the hood 1400 while the other side is removably fastened to hood 1400 with a hook-and-loop, button, snap, or magnetic fastener.

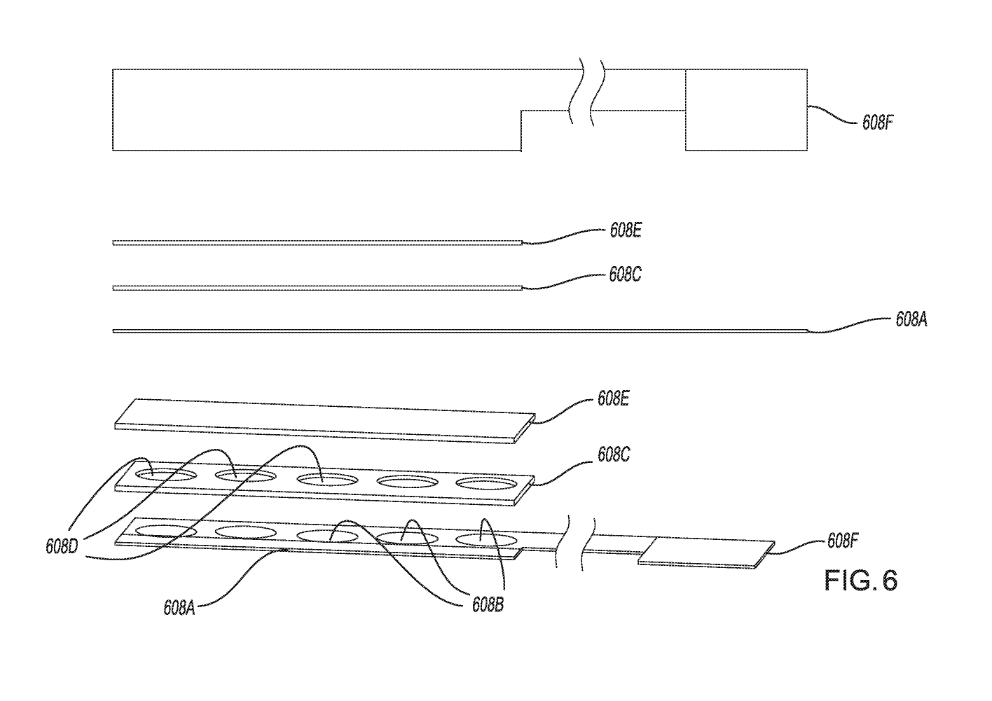

The sleeves 1500 include a single-stitched one inch turnback cuff 1504. A rubber tab 1502 with an adjustable hook-and-loop fastener that is configured to tighten or loosen the cuff of sleeve 1500. A thin nylon strap 1503 hanging from the cuff ends by a snap and can be used to secure gloves or other items to the sleeves, either during use or when the gloves are hanging loosely. Media controller 608 is a Bluetooth® wireless technology enabled remote control for an electronic device integrated into the left sleeve 1500. Media controller 608 is lightweight and thin and may instead be integrated anywhere in the jacket. As described in greater structural detail in connection with respect to FIG. 6, media controller 608 is thin, flexible, and lightweight and is configured to wirelessly communicate commands to an electronic device without requiring a wearer to retrieve the electronic device from a pocket.

Referring to FIGS. 1A-1J, Jacket 1000 includes both internal and external pockets. The internal surfaces of the pockets may be formed of soft materials (different than the outer surfaces of the jacket), that are selected to help protect and mitigate against scratching the devices contained therein. Upper right external pocket 1110 and lower right external pocket 1120 are formed on or through the external lining 1003 of the front right panel 1100. Upper left external pocket 1210 and lower right external pocket 1220 are formed on or through the external lining 1003 of the front left panel 1200. Upper right internal pocket 1130 and lower right internal pocket 1140 are formed through access strip 1108 of the front right panel 1100. Upper left internal pocket 1230 is formed on or through internal lining 1001 of the front left panel and lower left internal pocket 1240 is formed through access strip 1208 of the front left panel 1200. One or more flexible battery bank pockets 1350 are formed on or through the internal lining 1001 of back panel 1300.

An upper right external pocket 1110 is formed by inserting a hanging pocket bag 1110P between internal lining 1001 and external lining 1003 and bonding an open end of pocket bag 1110P to the inside of external lining 1003 corresponding to a horizontal opening 1111 in the front right panel 1100. Pocket bag 1110P in the illustrated implementation is dimension to be a 5.75″ wide×6.25″ deep and is formed of brushed tricot nylon material sealed on all sides except for an open side bonded around opening 1111. The pocket bag 1110P is thus constructed to be both strong and soft while also dimensioned and configured to securely store an electronic device or accessory. The opening 1111 can be covered or protected by pocket flap 1112, which can be made of the same material as external lining 1003. Pocket flap 1112 may include two (2) layers of material stitched together and may additionally include a rigid or semi-rigid material sandwiched between the layers to maintain a crisp pocket shape. The top of pocket flap 1112 is stitched to the external lining 1003 of front panel 1100 above opening 1111 and can be removably secured to front right panel 1100 below opening 1111 by a flap fastener 1113 (e.g., hook-and-loop, snap, button, or magnet) to keep the contents of pocket 1110 from falling out and to protect those contents from liquid, snow, or dirt ingress.

A lower right external pocket 1120 is provided that is in the form of a dual entry hand pocket that includes two separate cavities—a side entry pocket 1124 that can be accessed from the right side and a vertical entry pocket 1125 that can be accessed from above. A lower pocket material layer 1129′ is connected to the external lining 1003 and a pocket material layer 1129 is stitched to the lower pocket material layer 1129′. The two pocket material layers 1129, 1129′ are, in a preferred implementation, 8.75″ high and 7.5″ wide in dimension. Vertical entry pocket 1125 is formed as the cavity between lower pocket material layer 1129′ and pocket material layer 1129 when the left, right, and bottom sides of pocket material layer 1129 are connected to the lower pocket material layer 1129′. The right and bottom sides of pocket material layer 1129 are stitched to lower pocket material layer 1129′, while the left side of pocket material layer 1129 is connected by a hidden fastener 1126 (e.g., a zipper) and is adapted and dimensioned to unzip and provide greater access to the interior of vertical entry pocket 1125. Vertical entry pocket 1125 may include specific cavities such as a memory card storage pocket 1125A (e.g., a self-patch pocket adapted and dimensioned to store a memory card, an SD card, a micro-SD card, or even a spare device battery), a cable storage loop or strap 1125B (e.g., an elastic loop, a ring, a hook, or a fabric strap with a fastener), and a device storage cavity 1125C (e.g., a 5.75″ high×3.5″ wide power mesh with self-binding that has an elastic top and is stitched to the external layer 1003 on the left, right, and bottom sides)). The vertical entry pocket 1125 is covered and protected by a pocket flap 1122 that can be secured with a flap fastener 1123, similar to upper right external pocket 1110. Pocket flap 1122 is 2.25″ tall and 7.5″ wide. The pocket material layer 1129, lower pocket material layer 1129′, and pocket flap 1122 may be constructed from the same material as outer lining 1003. Another lining material, such as microfiber, media fur, or silk may optionally be used to line the inside of vertical entry pocket 1125 to protect devices contained therein from scratching.

Side entry pocket 1124 is formed as the cavity between external lining 1003 and lower pocket material layer 1129′. The top, bottom, and right sides of lower pocket material layer 1129′ are stitched to external lining 1003, leaving a 6.5″ high opening 1121 along the right side of the pocket. An additional stitch or bar tack across the top and bottom of the opening 1121 can reinforce the materials and keep the pocket 1121 from tearing away from the external lining.

In an alternate embodiment, lower right external pocket 1210 has only one pocket material layer 1129. The vertical entry pocket 1125 is formed between the external lining 1003 and the pocket material layer 1129, and the side entry pocket 1124 may be formed by bonding a pocket bag (not shown) to the inside of an opening through the external lining 1003. Still other embodiments may include only a vertical entry pocket or a side entry pocket.

As shown in FIGS. 1A-1J, lower left external pocket 1220 is formed as a dual entry hand pocket, similar to and vertically aligned with the lower right external pocket 1120, but in the present embodiment, pocket material layer 1229 of lower left external pocket 1220 is stitched to the external lining 1003 of front left panel 1200 on left, right, and bottom sides, lacking any feature corresponding to hidden fastener 1126 of lower right external pocket 1120. Additionally lower left external pocket 1220 may be positioned closer to zipper 1004 than lower right external pocket 1120. In other embodiments, lower left external pocket 1220 may be identical to lower right external pocket 1120 or the two pockets may be reversed in location.

As shown in FIGS. 1A, 1B, and 1E, upper left external pocket 1210 includes a pocket flap 1212 that is similar in construction to and vertically aligned with pocket flap 1112. Upper left external pocket 1210 is formed by inserting a pocket bag 1210P between internal lining 1001 and external lining 1003 with the open end of pocket bag 1210P bonded to a vertical opening 1211 in external lining 1003 that extends from the left edge of flap 1212 to the left edge of flap 1222. Upper left external pocket 1210 is sealed by zipper 1216 or another fastener. The pocket bag 1210P is dimensioned to be approximately as wide as pocket flap 1212 and approximately as tall as the distance between the connection points of pocket flap 1212 and pocket flap 1222. Additionally upper right external pocket 1110 may be positioned closer to zipper 1004 than upper left external pocket 1210.

In an alternative configuration, upper left external pocket 1210 may be formed with a similar structure as above, but as a dual-entry pocket by bonding a second hanging pocket bag 1210P′ corresponding to a second opening 1211′ in external lining 1003 formed horizontally beneath pocket flap 1212. Second pocket bag 1210P′ may hang either in front of or behind pocket bag 1210P.

Referring to FIG. 5, flexible battery bank 500 includes one or more battery cells 501 (e.g., lithium ion or lithium polymer) connected to a battery control circuit 502 designed to control battery performance including charging and discharging. Input port 503 (e.g., a micro-USB plug) and output port 504 (e.g., USB plug) are connected to battery control circuit 502. Battery control circuit 502 stores power in battery cells 501 when power is received through input port 503. Battery control circuit 502 controls whether to provide power from battery cells 501 to output port 504 when an electronic device is connected to output port 504.

Most USB devices and chargers operate at 5 volts, and can draw or provide different levels of current (e.g., 0.5 amps, 1.0 amp, or 2.1 amps), while most battery cells are optimally charged or discharged at a voltage between 3.6 v and 4.2 v. To accommodate this differential, the battery control circuit 502 boosts voltage from the battery cells 501 to 5 volts at output port 504 and decreases or bucks input voltage from 5 volts at input port to a lower voltage safe for battery charging. Battery control circuit 502 also includes safety and charge optimization circuitry to avoid damage from over-charging and to prolong the life of the battery cells 501.

Flexible battery bank 500 also includes a button 507 and a charge indicator 506, which includes a series of LEDs. Battery control circuit 502 illuminates a number of LEDs in charge indicator 506 corresponding to the remaining charge level or flexible battery bank 500 (e.g., each LED of a 4-LED charge indicator 506 could represent 25% of the total charge in flexible battery bank 500 with 2 LEDs illuminating to represent a 50% charge or 3 LEDs illuminating to represent a 75% charge).

A flexible housing 507 may be formed of any suitable flexible material (e.g., silicone, rubber, or thermoplastic urethane (TPU)) formed around linearly arranged and spaced apart battery cells 501, battery control circuit 502, input port 503, output port 504, button 505, and charge indicator 506. The flexible housing may be formed of one or more opposing layers sealed over the foregoing components to one another or may be molded over the foregoing components. Input port 503, output port 504, and button 505 are all accessible through openings in flexible housing 507, and charge indicator 506 is visible through transparent portions of flexible housing 507. Flexible housing 507 is configured to be flat on one side and raised sections corresponding to the battery cells 501 project from the opposite side. Flexible housing 507 includes partition gaps 508 between the battery cells 501, the partitions 508 being configured and positioned to allow the flexible battery bank to bend/flex or hinge at the partitions 508. The battery bank is thus capable of being hinged over itself at the partitions 508. The flexible housing 507 also may provide additional cushioning and water protection to the internal elements and may include rigid structural support elements positioned to surround one or more sides of the battery for protection. In the illustrated embodiment, the flexible battery bank is thin (e.g., only slightly thicker than a USB port), rectangular, and dimensioned to fit in a 8.5″ wide and 4″ high pocket. In the present embodiment, the output port 504 is positioned parallel to the longitudinal length at a relatively thin edge region near the corner.

As shown in FIGS. 1F and 1G, jacket 1000 includes two flexible battery bank pockets 1350 secured to the back panel 1300. In the present embodiment, each flexible battery bank pocket 1350 is formed as a 8.5″ wide and 4″ deep pocket bag 1450P and is adapted and dimensioned to optimally fit a flexible battery bank 500. In the present embodiment, the flexible battery bank pockets 1350 are horizontally oriented, and each flexible battery bank pocket 1350 is secured at the back yoke 1303 and at the side seam between back panel 1300 and front panels 1100, 1200. Each flexible battery bank pocket 1350 includes a horizontally oriented flex battery pocket zipper 1356, through which the flexible battery bank 500 can be accessed, inserted, and removed. Each flexible battery bank pocket 1350 also includes a 0.75″ rubber eyelet 1352 positioned near a lower corner of the flexible battery bank pocket 1350 nearest the seam between the back panel 1300 and the nearest front panel 1100, 1200, the rubber eyelet 1352 positioned and configured so that a cable or cord can pass from the interior of flexible battery bank pocket 1350 to the interior of the jacket 1000 (outside the pocket 1350). The flexible battery bank pockets 1350 are positioned and oriented to be located at a wearer's lower back, and the flexible battery banks 500 are configured and positioned to fit with the flat side facing away from the back panel 1300 (i.e., the flat side will point toward the wearer). When the battery banks 500 are positioned with the flat side facing away from the back panel 1300, the output port 504 is configured to align with the eyelet 1352 to more efficiently manage cables and minimize cable crimping.

The Upper right internal pocket 1130 is formed by bonding a 6.5″ high×4.75″ wide brushed tricot hanging pocket bag 1130P to the inside of a vertical opening 1131 formed between the top and mid-point of access strip 1108 between outer zipper 1004 and attachment zipper 1009. Upper right internal pocket 1130 can be opened and closed with zipper 1136. Upper right internal pocket 1130 includes a 0.375″ metal eyelet 1132 above zipper 1136 on access panel 1108, allowing a cable to run from the access panel 1108 into the pocket bag 1130P without opening zipper 1136. One or more cord tunnels 1004 are mounted in the access panel 1108 above the eyelet 1132. The pocket 1130, eyelet 1132, and cord tunnels 1004 are configured, positioned, and dimensioned so that a headphone cable can be securely run from an electronic device in upper right internal pocket 1130, through the eyelet 1132, along the cord tunnels 1004 up access panel 1108 to a wearer's ears or neck.

The Lower right internal pocket 1140 is formed by bonding a 9.0″ high×9.5″ wide brushed tricot hanging pocket bag 1140P to the inside of a vertical opening 1141 formed between the mid-point and bottom of access strip 1108 between outer zipper 1004 and attachment zipper 1009. Lower right internal pocket 1140 can be opened and closed with zipper 1146. Lower right internal pocket 1140 includes a 0.375″ metal eyelet 1142 below zipper 1146 on access panel 1108, allowing a cable to run from the access panel 1108 into the pocket bag 1130P without opening zipper 1146.

Any pocket or eyelet positioned along the access panel is configured to be fully accessible whether the jacket 1000 is worn with or without a liner 200 connected thereto. Because liner zipper 209 of liner 200 connects to attachment zipper 1009 of jacket 1000, liner 200 when inserted into the shell blocks access to internal jacket elements between attachment zipper track 1009A and attachment zipper track 1009B. The access panel is configured to position pocket and eyelet access in a location that allows accessibility when a liner 200 is attached. The liners may include pockets or zippers to allow access to internal jacket.

Vertically aligned cord tunnels 1005 are positioned on front right panel 1100 adjacent the seam joining back panel 1300, the cord tunnels being vertically positioned between the level of the flexible battery bank eyelet 1352 and the turnback hem 1104. Additional horizontally aligned cord tunnels 1005 are positioned along the upper edge of the turnback hem 1104. The pocket 1140, eyelet 1142, cord tunnels 1004, and eyelet 1352 are configured, position, and dimensioned so that a power or data cable (e.g., a USB cable) can be securely run from an electronic device in lower right internal pocket 1140, through the eyelet 1132, along the cord tunnel 1005 path to a flexible battery bank 500 located in flexible battery bank pocket 1350.

As shown in FIGS. 1F-1H, upper left internal pocket 1230 is formed as a top-entry cavity between pocket material layer 1239 and internal lining 1001 when the left, right, and bottom sides of pocket material layer 1239 are stitched to the internal lining 1001 of the front left panel. The upper left internal pocket 1230 corresponds in dimension and position to the upper left external pocket 1210 and may be 5.75″ wide with a height corresponding to the distance between the top pocket flap 1212 and the bottom pocket flap 1222. Pocket material layer 1239 includes a 0.75″ rubber eyelet 1232 located at the bottom corner closest to the attachment zipper 1009. Rubber eyelet 1232 provide a loose seal, but allows a cable to pass from pocket 1230 to the interior of the jacket 1000 without running additional loose cable over the top of pocket 1230. An accessory strap 1234 and a surface pocket 1236 are disposed on the outside surface of pocket material layer 1239 facing away from the interior lining 1001 of front left panel 1200.

In the present embodiment, the accessory strap 1234 is 0.75″ wide and 1.75″ long, including one end fixed to the pocket material layer 1239 and an opposing end including a fastener 1235 (e.g., a hidden magnetic closure or hook-and-loop fastener) that can be removably secured to a corresponding fastener 1235 of the pocket material layer 1239. The accessory strap 1234 is dimensioned and configured to function as a quick-release headphone or earbud holder.

Surface pocket 1236 is configured and dimensioned to secure a compact battery bank and provide power to an electronic device stored in upper right internal pocket 1230. The surface pocket 1236 is 3 inches tall and 3.25″ wide and is stitched to the pocket material layer along the top, bottom, and left sides. Surface pocket 1236 has a cavity facing toward the attachment zipper 1009. One end of strap 1237 is secured to the outside of the surface of pocket material layer 1239 and the other end of strap 1237 includes a hook-and-loop fastener 1238. Strap 1237 is configured and positioned to secure the compact battery bank inside of the cavity when the fastener 1238 is affixed to a corresponding fastener 1238 on the outside of the surface pocket 1236. Surface pocket 1236 is positioned and oriented so that a cable connected to a compact battery bank secured in surface pocket 1236 will be positioned in close proximity to rubber eyelet 1232.

Surface pocket 1236 is configured, positioned, and oriented so that a rectangular battery bank that is 3.5″ wide, 2.25″ tall, and 0.25″ thick with a rotating integral cable secured in surface pocket 1236 would be well positioned and oriented to direct its integrated cable through rubber eyelet 1232 to provide power to an electronic device in upper left internal pocket 1230.

In the present embodiment, lower left internal pocket 1240 is structurally identical to lower right internal pocket described above. One or more vertically aligned cord tunnels 1005 is positioned on front left panel 1200 adjacent the seam joining back panel 1300, the cord tunnels being vertically positioned between the level of the flexible battery bank eyelet 1352 and the turnback hem 1204. Additional horizontally aligned cord tunnels 1005 are positioned along the upper edge of the turnback hem 1204. The pocket 1240, eyelet 1242, cord tunnels 1004, and eyelet 1352 are configured, position, and dimensioned so that a power or data cable (e.g., a USB cable) can be securely run from an electronic device in lower right internal pocket 1240, through the eyelet 1232, along the cord tunnel 1005 path to a flexible battery bank 500 located in flexible battery bank pocket 1350.

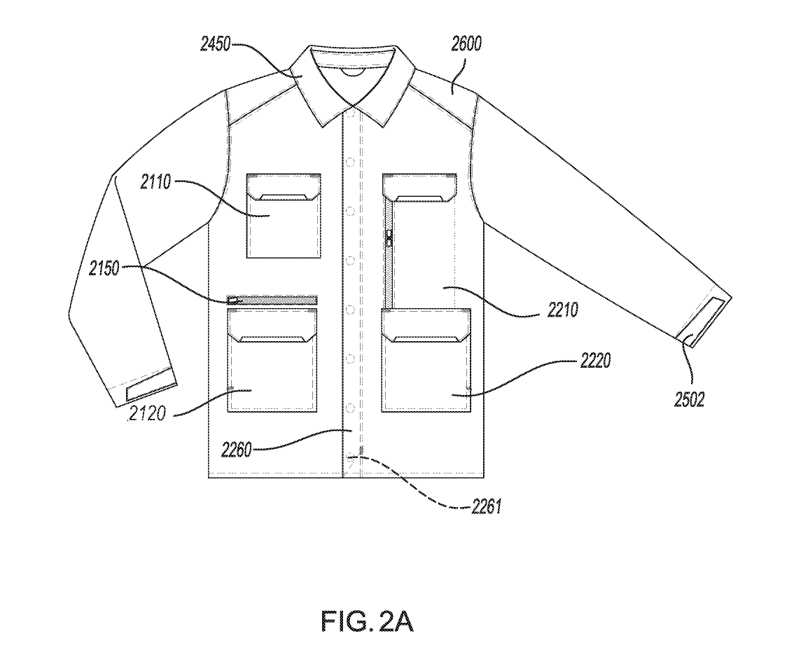

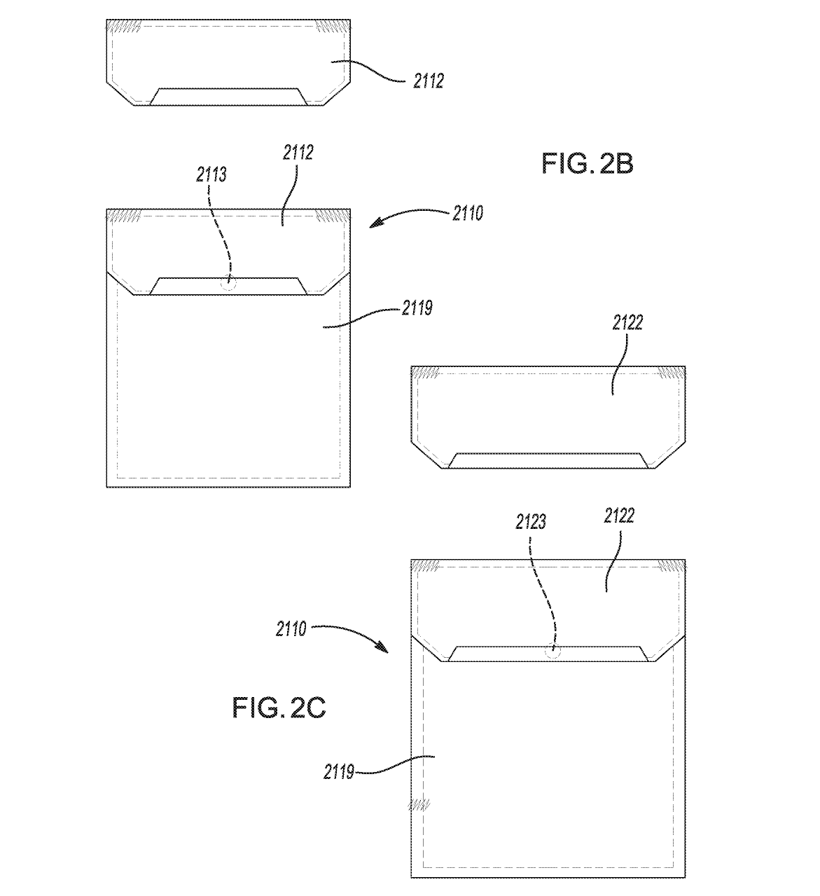

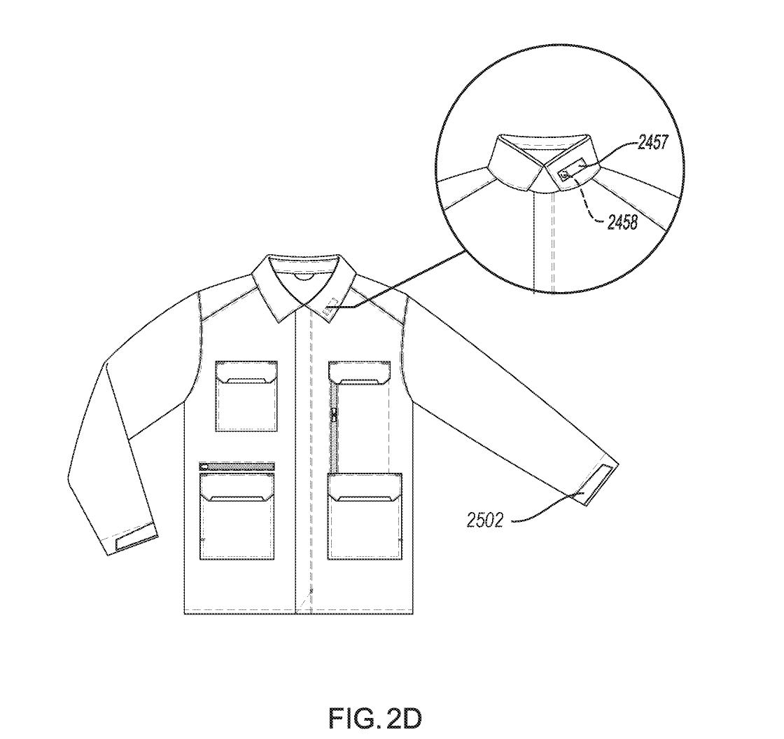

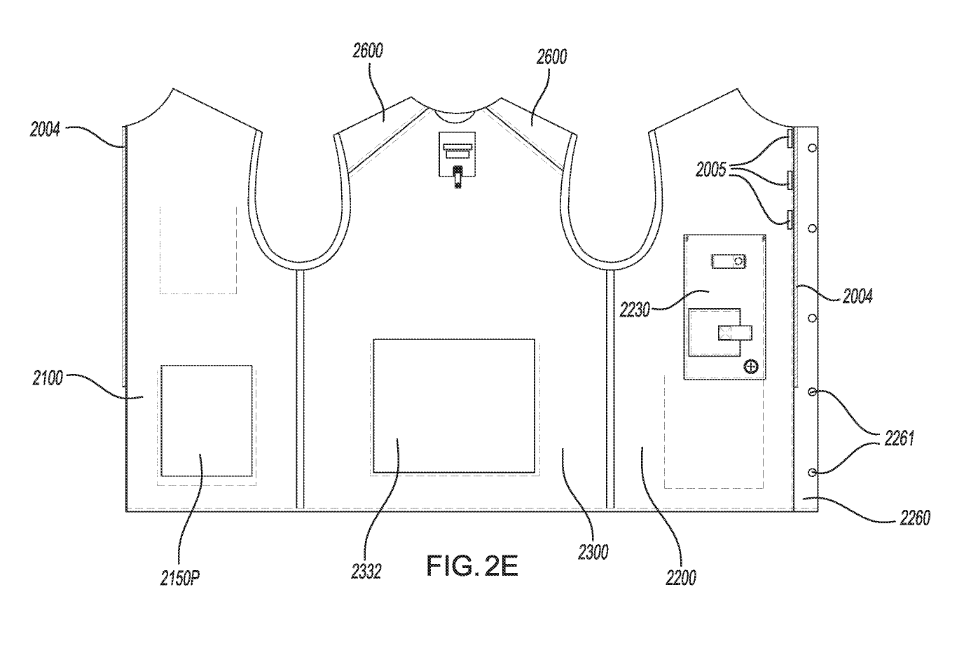

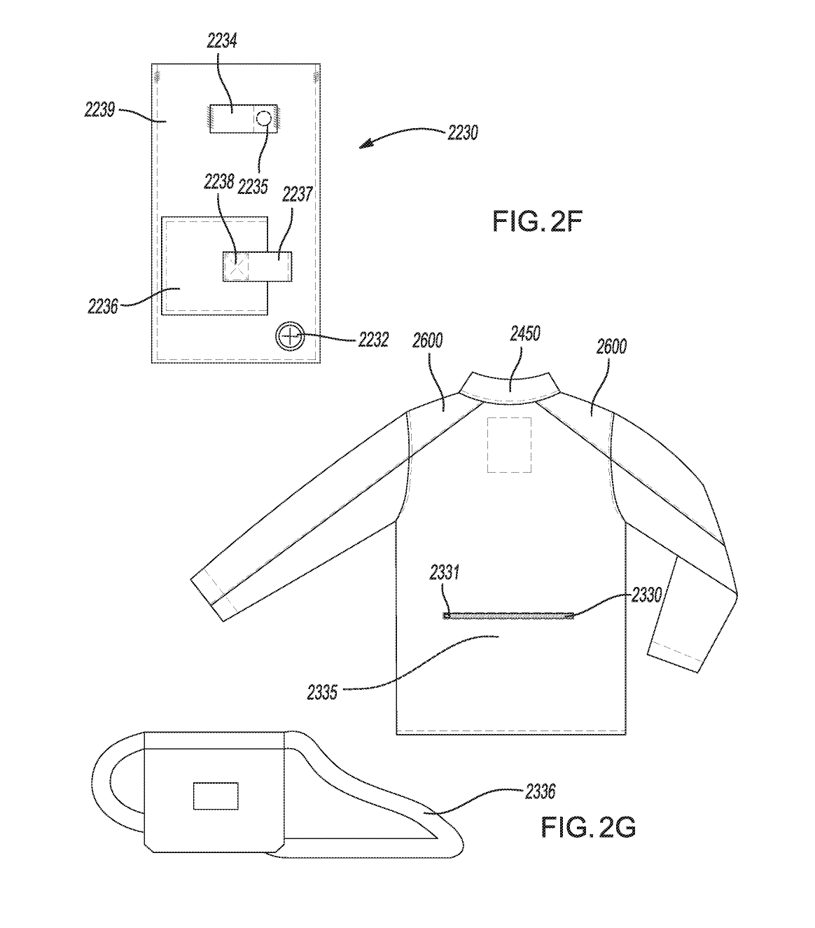

FIGS. 2A-2G show an alternate embodiment of a jacket 2000 including a hanging self pocket bag 2332 is attached to the inner surface 2001 of the unitary back panel 2300 aligned with an opening 2701 through the back panel 2300. Pocket bag 2332 is 10.5″ wide and 9.5″ tall. A zipper 2730 with a reversible slider 2731 is affixed to the opening 2701, and pocket bag 2332 can be used as a regular pocket for storage. When pocket bag 2332 is turned inside out, it becomes a sling pack 2335 with a 1.25″ wide strap 2336 and a metal clasp 2337. The whole jacket 2000 can be packed inside sling pack 2335 and worn over a shoulder, similar to a messenger bag.

Jacket 2000 additionally includes shoulder panels 2600 between the front panels 2100, 2200 and the back panel 2300, and a collar 2450. The front panels, back panel, and sleeves 2100, 2200, 2300, 2500 of jacket 2000 are double needle straddle stitched together. Jacket 2000 has shoulder seams in front and behind shoulders panels 2600, but jacket 2000 does not have a seam at the top of the shoulder. Jacket 2000 is a single-layer shell and does not connect to a liner 200 or include a flexible battery bank pocket.

In the present embodiment, the zipper 2004 stops 5.0″ above the bottom of the jacket. The left front panel 2200 includes a placket 2260 covering the zipper 2004, and hidden magnetic fasteners 2261 in the placket 2260 fasten to corresponding hidden magnetic fasteners in the right front panel 2100 to hold the placket in place. A number of cord tunnels 2005 run vertically along the interior of zipper 2004 and these cord tunnels are configured and positioned to route and retain a headphone cable from an electronic device stored in upper left internal pocket to collar 2450.

The collar 2450 may be single needle stitched to the front panels, shoulder panels, and back panel 2100, 2200, 2300, 2500. Additionally collar 2450 includes an under collar flap 2457 with a hidden magnetic closure 2458, configured to hold a headphone or earbud in place.

Additionally sleeve 2500 includes a 4″ long and 1.5″ wide nylon tab 2502 with an adjustable hook-and-loop fastener.

In addition to the sling pack 2335 that doubles as a large back pocket, the present embodiment illustrates a different configuration of pockets from the previous embodiments. Jacket 2000 includes fewer pockets than the previous embodiment, and some of those pockets have been reduced in size to match the lighter overall jacket. Lower right external pocket 2120 does not include the hidden fastener 2126 or device storage 2125A-C present in the previous embodiment.

In the present embodiment, upper right external pocket 2110 is formed by bonding a pocket material layer 2119 to the outside of the front right panel 2100 of right front panel 2100. The pocket material layer 2119 is 5.75″ high and 5.0″ wide. Upper right external pocket 2110 is formed as the cavity between pocket material layer 2119 and the outside of the front right panel 2100 when the left, right, and bottom sides of pocket material layer 2119 are bonded to the outside of the front right panel 2100. Upper right external pocket 2110 is covered by a flap 2112 that is 2.0″ tall and 5.0″ wide. The pocket material layer 2119 and pocket flap 2112 may be constructed from the same material as the front right panel 2100.

An additional middle right external pocket 2150 is positioned 0.75″ above the lower right external pocket 2120 in the front right panel 2100. Middle right external pocket 2150 is formed by bonding an open end of hanging pocket bag 2150P to the inside of front right panel 2200 corresponding to a horizontal opening 2151 through the front right panel 2100. Pocket bag 2150P is 6.5″ wide and 6.0″ deep. A zipper 2156 is bonded to opening 2151 above pocket bag 2150P. Each of the pocket flaps, 2112, 2122, 2212, 2222 is secured by a hidden snap closure and includes a plastisol or glosstisol print along a lower edge.

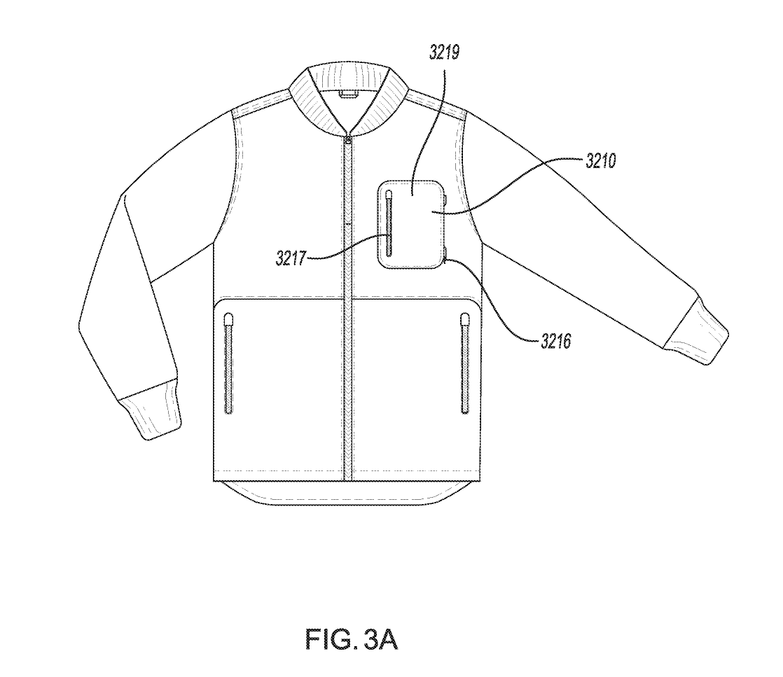

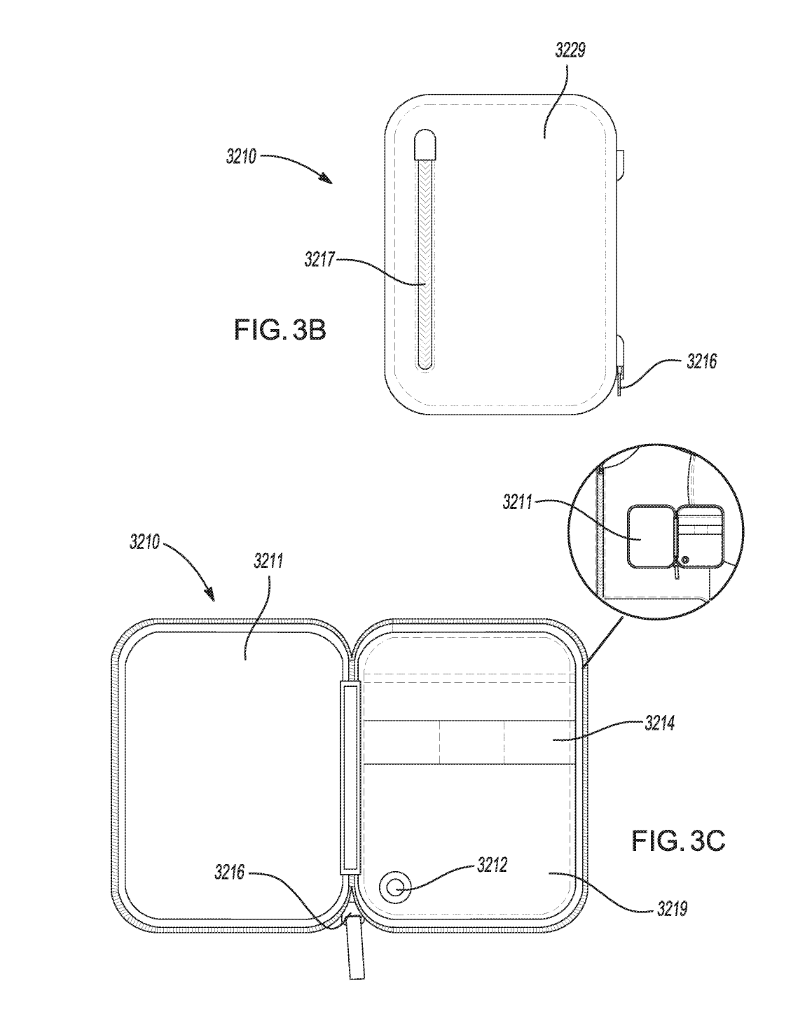

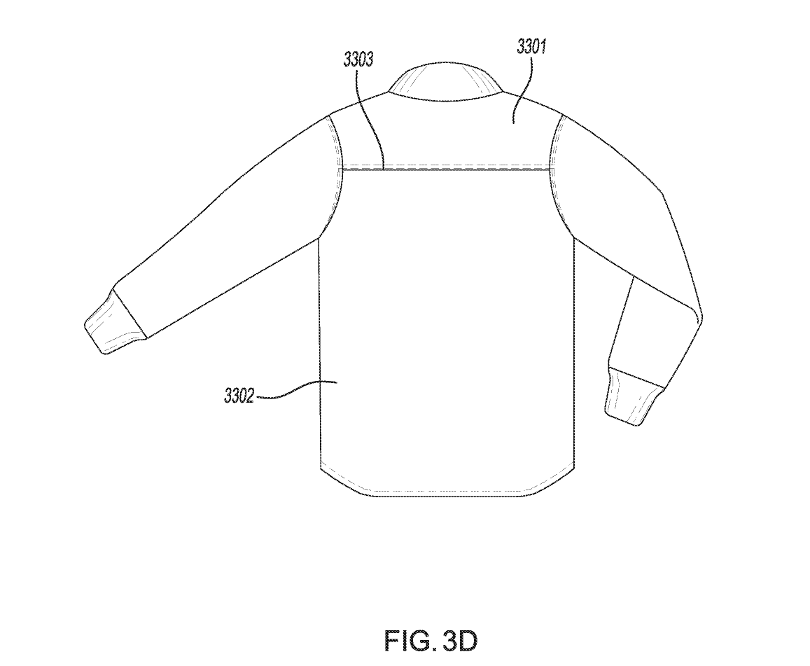

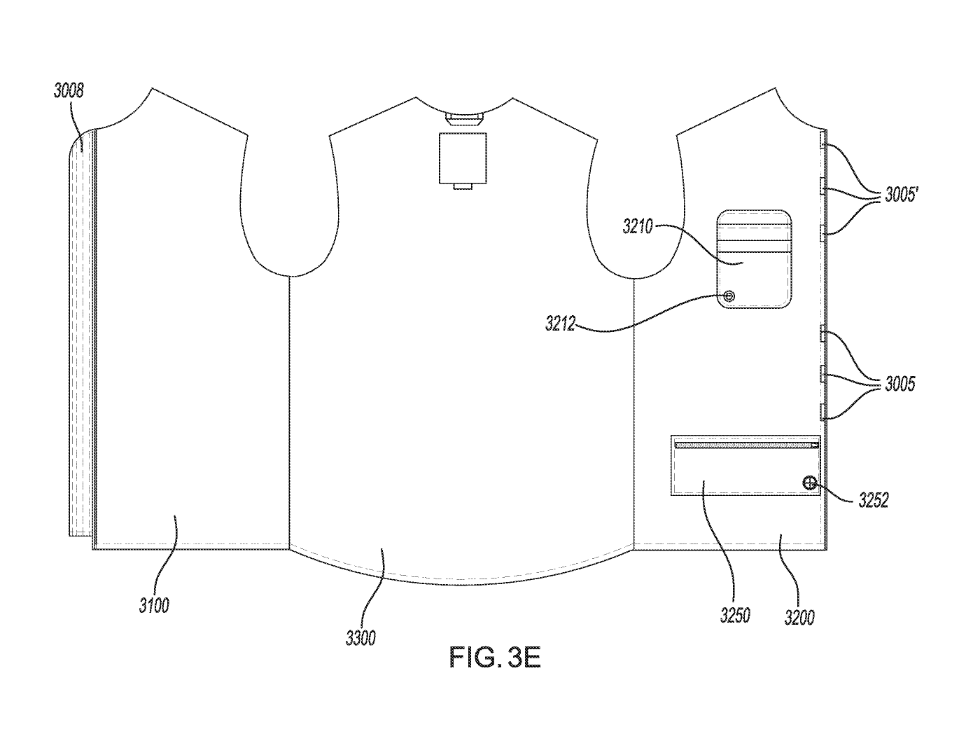

FIGS. 3A-3E illustrate a third embodiment of a jacket 3000, incorporating an upper left external pocket 3210 that opens from the exterior to the interior of the jacket. The left side of pocket layer 3219 is fixed to the front left panel 3200. A zipper 3216 runs along the exterior of pocket layer 3219 from the top of the fixed left side along the top side, around the right side, along the bottom side and to the bottom of the fixed left side of pocket layer 3219. The zipper 3216 is configured so that when fully unzipped, an opening 3211 corresponding in size and location to the pocket layer 3219 opens through front left panel 3200, but when zipper 3216 is fully zipped, pocket layer 3219 fully covers opening 3211.

Pocket layer 3219 includes an insert, such as EVA foam (not shown), for rigidity. The outer surface 3003 of pocket 3210 includes a separate vertical zipper 3217 configured to provide storage inside of pocket layer 3219. The inner surface of pocket 3210 includes a an elastic strap 3214 including stitched details configured to form multiple separate elastic loops from the single strap. A 0.375″ metal eyelet 3212 provides cable access from the interior of the jacket to the same cavity in pocket layer 3219 that is accessed through zipper 3217 on the exterior of pocket layer 3219.

A flexible battery bank pocket 3250 is bonded horizontally to the front left panel 3200 below the upper left pocket 3210. The flexible battery bank pocket 3250 is configured and dimensioned to contain a flexible battery bank 500. Flexible battery bank pocket 3250 is secured to jacket 3000 at the side panel seams and hem. Flexible battery bank pocket 3250 includes zipper 3256 for accessing, inserting, and removing flexible battery bank 500 into pocket 3250 and eyelet 3252 to allow a cable to pass from the interior of flexible battery bank pocket 3250 to the interior of the jacket when the zipper is closed.

Jacket 3000 includes a zipper track 3004A bonded along the edge of front left panel 3200 furthest from back panel 3300 and a corresponding zipper track 3004B bonded along the edge of front right panel 3100 furthest from back panel 3300. A 2″ wide zipper guard 3008 is bonded to the front right panel 3100 interior to the zipper track 3004B and configured to keep fabric from getting caught in the zipper 3004.

A first plurality of cord tunnels 3005 are mounted to the inner surface 3001 of the front left panel 3200 interior to zipper track 3004A between the flexible battery bank pocket 3250 and the upper left external pocket 3210. The cord tunnels 3005 are configured and positioned to route a power cord (.e.g., a USB cable) exiting flexible battery bank pocket 3250 through rubber eyelet 3252 along the interior of the jacket zipper 3004 to the metal eyelet 3212 in upper left external pocket 3210.

A second plurality of cord tunnels 3005′ are mounted to the inner surface 3001 of the front left panel 3200 interior to zipper track 3004A between the upper left external pocket 3210 and the collar 3400. The cord tunnels 3005′ are configured and positioned to route a headphone cable exiting the upper left external pocket 3210 through metal eyelet 3212 along the interior of the jacket zipper 3004 to the collar 3400.

FIGS. 4A-4H illustrate a fourth embodiment of a jacket 4000, including side panels 4700, 4800 and incorporating a packable hood 4400, sleeve cable passages 4506, rear pocket 4310, and side flexible battery bank pockets 4750, 4850 upper left external pocket 3210 that opens from the exterior to the interior of the jacket.

Jacket 4000 is constructed of front right panel 4100, right side panel 4700, back panel 4300, left side panel 4800, front left panel 4200, collar 4450, and sleeve 4500. Right side panel 4700 is bonded between front right panel 4100 and back panel 4300. Left side panel 4800 is bonded between front left panel 4200 and back panel 4300. Right and left side panels 4700, 4800 are shorter than front and back panels 4100, 4200, 4300. Sleeves 1500 are bonded into the opening between front panels 4100, 4200 and back panel 4300 at the top of side panels 4700, 4800. Collar 4450 is bonded to the top edge of front and back panels 4100, 4200, 4300.

As well shown in FIGS. 4A, 4E and 4F, collar 4450 is 3.5″ tall and extends vertically from a neck hole formed between the front and back panels 4100, 4200, 4300. A horizontally oriented collar zipper 4456 is formed in a horizontally oriented collar opening 4451 midway up collar 4450. When collar zipper 4456 is opened, a hidden hood 4400 can be rolled out from inside the collar opening 4451. Hidden hood 4400 is configured and dimensioned to be a fully formed weather-protective hood when unrolled and also fully concealable inside collar opening 4451 when rolled up. DTM webbing 4461 runs inside a webbing tunnel 4464 along a front edge of hidden hood 4400 and emerges from a 0.375″ metal eyelet 4466 on either side of hidden hood 4400. Outside metal eyelet 4466, DTM webbing 4461 passes through webbing adjuster 4463 and is secured to the bottom of hidden hood 4400 with bartack 4462. Webbing adjuster 4463 can be adjusted to tighten hidden hood 4400 around a wearer's face. DTM webbing 4461 is flat and easily rolls up with hidden hood 4400 when hidden hood 4400 is stored in collar zipper 4456.

A right side panel flexible battery bank pocket 4750 is mounted vertically alongside panel 4700 and a left side panel flexible battery bank pocket 4850 is mounted vertically alongside panel 4800.

As shown in FIG. 4H, a plurality of cord tunnels 4005 are bonded to each of the front panels 4100, 4200 along the seams with side panels 4700, 4800 between the hem and the height of the rubber eyelet. Additional cord tunnels 4005 are bonded above the lower turnback hem of the front panels 4100, 4200 configured and positioned to route a cable to the metal eyelets 4142, 4242 of lower right internal and lower left internal pockets 4140, 4240. Additional cord tunnels 4005 are bonded to the left front panel 4200 along the seam with left side panel 4800 between the height of the rubber eyelet 4852 and the height of a rubber eyelet connected to upper left external pocket 4110. Additional cord runnels 4005 are positioned in each of the access panels 4008, 4009 between the collar 4450 and the metal eyelets 4132, 4232 associated with upper right internal pocket 4130 and upper left internal pocket 4230. The cord tunnels 4005 are configured and positioned to securely route a power cable from a flexible battery bank 500 contained within the flexible battery bank pockets 4750, 4850 through eyelets 4132, 4232, 4112 to an electronic device secured in pockets 4130, 4230, 4110.

As well shown in FIGS. 4A, 4B, and 4G, zipper 4004 is disposed beneath a placket 4260 bonded to front left panel 4200. Placket 4260 contains hidden magnetic closures 4261 that secure to corresponding hidden magnetic closures disposed in the front right panel 4100. Placket 4260 covers zipper 4004 and provides an additional layer of protection from wind and water ingress between the teeth of zipper 4004. Placket 4460 extends from a first access strip 4208. A first track of zipper 4004 is disposed at an outer edge of the access strip 4208. A second track of an attachment zipper 4009 is disposed on an inner edge of the access strip 4208. A second access strip 4108 is positioned between a second track of outer zipper 4004 and a first track of attachment zipper 4009.

As shown in FIG. 4C, a cable passage 4506 is included near a cuff 4501. The cable passage 4506 includes a passage flap 4506C secured to the interior of sleeve 4500. The cable passage includes a cable entry point 4506A between two stitched bar tacks 4506B The passage flap 4506C includes a hidden hook-and-look fastener 4506D. A wearer can run a cable (e.g., a mini stereo or 3.5 MM jack) down sleeve 4500 and insert the jack through entry point 4506A. Bar tacks 4506B maintain the cable jack in position under the passage flap. When a wearer wants to plug a device into the jack, the wearer can detach the hook-and-loop fastener 4506D, pull back the passage panel 4506C and pull the cable jack long enough to plug into an electronic device. The cable may also be run through shockcord loops 4506E (see FIGS. 4G and 4H) at the base of the armhole to further stabilize the cable within the sleeve.

As shown in FIGS. 4F and 4G, jacket 4000 includes a large center pocket 4350 formed through the external lining 1003 of the back panel 4300. The large center pocket 4350 is formed by bonding the top, bottom, left, and right sides of a mesh panel 4352 to the interior of lower back panel 4302. A zipper 4356 is bonded to an opening 4351 formed between upper back panel 4301 and lower back panel 4302. The zipper is configured with the slider and tab facing outwardly through the back panel 4300.

As shown in FIG. 6, media controller 608 is a relatively thin remote control that can send wireless commands to an electronic device. Media controller 608 is comprised of a very thin keyboard 608A containing a plurality of keys 608B. Keyboard 608A may include 5 keys 608B configured to send or perform the commands power/pair, play/pause/answer call/hang up, volume up, volume down, and camera shutter control respectively. A silicone spacer 608C with holes 608D positioned to correspond to keys 608B is positioned on top of keyboard 608A. A conductive silicone rubber sheet 608E is positioned on top of the silicone spacer. Keyboard 608A is connected to a control box 608F containing a coin cell battery, a BLE chip, and a system controller. As shown in FIG. 1E, media controller 608 can be positioned and bonded under the material of sleeve 1500 near the cuff 1501. Button Labels 608G indicating each button's functionality can be printed on the surface of the sleeve over the corresponding key 608B. Conductive silicone rubber sheet may include raised elements to indicate button location. Alternatively button labels 608G may include a raised ink outline or bump to indicate button locations. Media controller 608 is configured so that when conductive silicone rubber sheet 608D is depressed, conductive silicone rubber sheet 608D makes contact with a specific key 608B through a hole 608D in silicone spacer 608C, which sends a signal from keyboard 608A to BLE Box 608F, and media controller 608 is configured to either performs a function or transmit an instruction to the electronic device, the instruction being previously assigned to that key 608B. Media controller 608 is configured to be thin, flexible, and durable. Media controller 608 is configured to wirelessly communicate with an electronic device through a wireless protocol such as Bluetooth Low Energy® or iBeacon™ wireless technology.

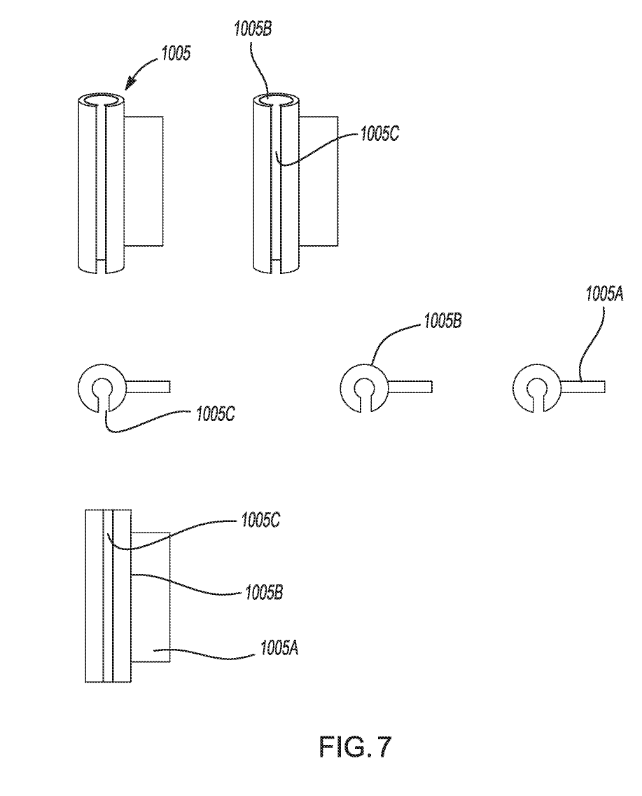

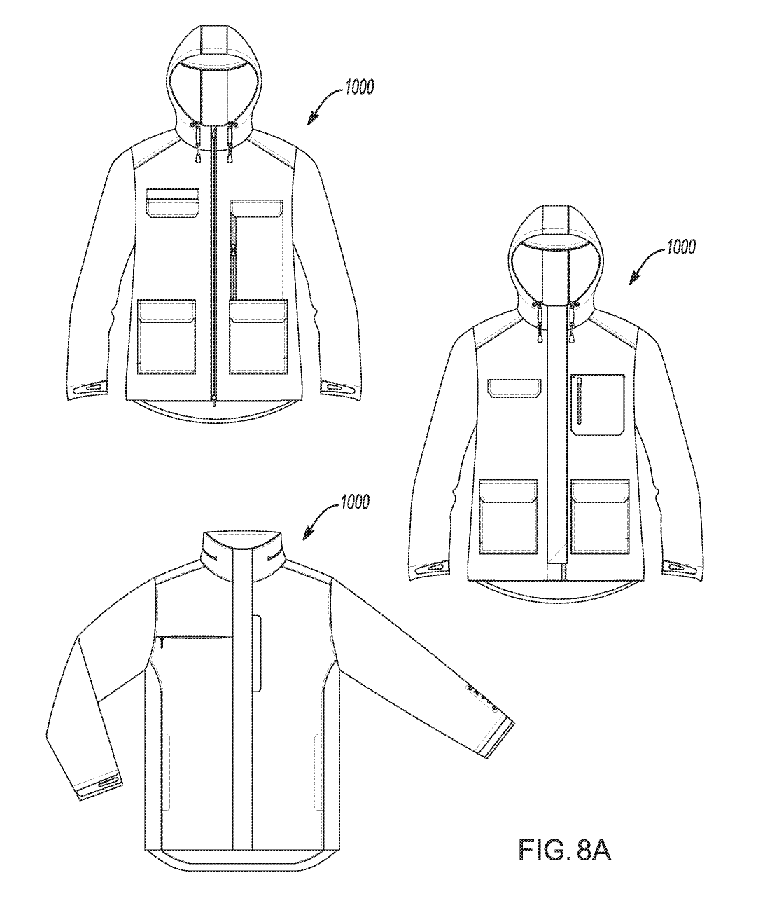

As shown in FIG. 7, cord tunnels 1005 include an attachment portion 1005A connected to a hollow tunnel 1005B with an access cutout 1005C, adapted and dimensioned to allow a cable to be intentionally inserted into the hollow tunnel 1005B, where it will remain secured until intentionally removed. Cord tunnels may be formed as a unitary element. Cord tunnels may be formed of a flexible (e.g., rubber, silicone, or TPU) or rigid (e.g., wood, metal, polycarbonate) material molded or co-molded in layers or may be covered or formed in whole or part of fabric. The attachment portion 1005A may be 1.5 millimeters long and 19.0 millimeters wide. The hollow tunnel 1005B may be 25.4 millimeters long with an inner diameter of 3.0 millimeters and an outer diameter of 6.5 millimeters. The access cutout 1005C may be 1.1 millimeters wide. The cord tunnels 1005 guide power cables conveniently from a pocket containing a battery bank or accessory to pocket containing an electronic device. Cord tunnels are configured to guide headphone cables from a pocket containing an electronic device to a more convenient user location.

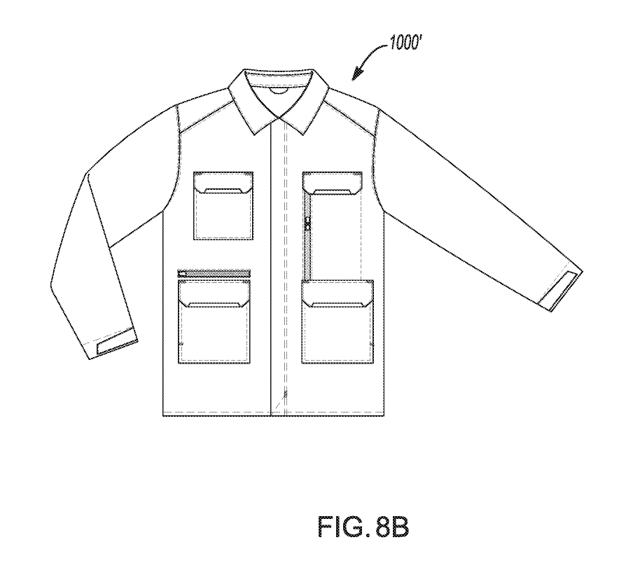

FIG. 8A is a compilation of outer shells that are configured to couple with the interface zipper system. FIG. 8B is an example of an outer shells that is not configured to couple with the interface zipper system. The three (3) jackets 1000 are configured to couple with any liner incorporating the interface zipper system. Attachment zipper first track 1009A and attachment zipper second track 1009B (inside the jacket) of the top two jackets are configured to couple to liner zipper first track 209A and liner zipper second track 209B of a liner 200, respectively. The jacket 1000′ does not include attachment zippers 1009 capable of coupling to a liner 200 incorporating the interface zipper system.

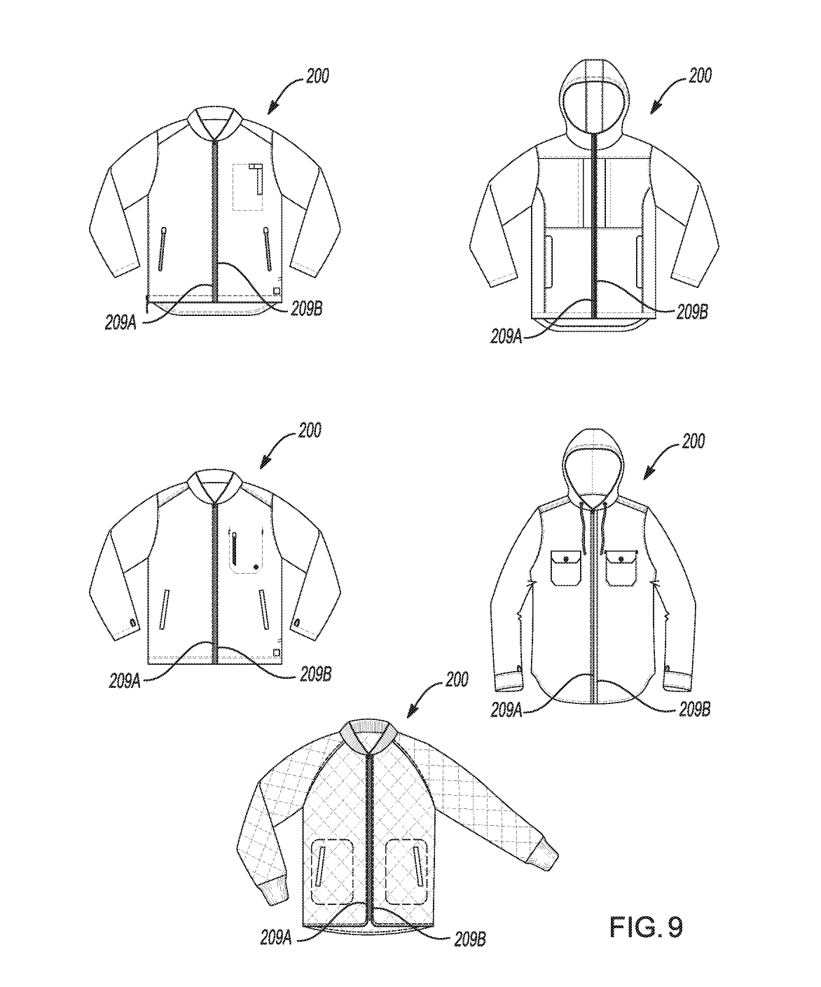

FIG. 9 is a compilation of liners that work with the interface zipper system. Any of the liners 200 illustrated in FIG. 9 is configured to couple with the three (3) jackets 1000 of FIG. 8A. First track 209A can couple to second track 209B as shown; however, first track 209A is additionally configured to couple to first track 1009A and second track 209B is additionally configured to couple with second track 1009B, connecting liner 200 to jacket 1000.

Compatible liners 200 and jackets 1000 can be mixed and matched, allowing users to adjust elements of an outfit according to weather and style without requiring entire new outfits. As previously described, jackets 1000 and liners 200 can also each be used independently.

While the disclosure has been described in connection with specific examples and various embodiments, it should be readily understood by those skilled in the art that many modifications and adaptations of the invention described herein are possible without departing from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

1. An article of clothing comprising:
a jacket configured to form an interior body cavity around a user when worn, the jacket including a neck opening, a waist opening, and sleeves all connected to the interior body cavity, the jacket having an inner surface and an outer surface;
a rechargeable battery having an output port;
a battery pocket including a battery eyelet configured and dimensioned to pass a cord from outside the battery pocket to inside the battery pocket, the battery pocket being configured and dimensioned to hold the rechargeable battery and to orient the battery in a way to position the output port in the direction of the battery eyelet;
one or more device pockets attached to the jacket and including a closable device pocket opening and a device eyelet configured and dimensioned to pass a cord from inside the device pocket to the interior body cavity of the jacket outside of the device pocket;
a plurality of cord tunnels connected to the inner surface of the jacket, one or more of the cord tunnels being configured and positioned to route and secure a cord between the battery eyelet and the device eyelet, one or more of the cord tunnels being secured to the inner surface of the jacket adjacent the waist opening; and
a wireless media controller bonded to the outer surface of one of the sleeves and including a plurality of buttons, the wireless media controller being configured to send a wireless instruction to an electronic device in response to activation of a button.

2. The article of clothing of claim 1, further comprising:
a detachable internal liner configured to be closed by a liner zipper and at least one liner eyelet corresponding in position to a device eyelet or battery eyelet when the internal liner is attached to the jacket and configured to allow a cord to pass through the internal liner;
wherein the jacket further comprises a first jacket zipper, a second jacket zipper, and an access panel located between the first jacket zipper and the second jacket zipper, the jacket being configured to be closed by the first jacket zipper, one or more of the cord tunnels being secured along the access panel; and
wherein the internal liner is configured to be attached to the jacket by zipping the second jacket zipper to the liner zipper.

3. An article of clothing comprising:
a jacket configured to form an interior body cavity around a user when worn, the jacket including a neck opening, a waist opening, and sleeves all connected to the interior body cavity, the jacket having an inner surface and an outer surface;
a rechargeable battery having an output port;
a battery pocket including a battery eyelet configured and dimensioned to pass a cord from outside the battery pocket to inside the battery pocket, the battery pocket being configured and dimensioned to hold the rechargeable battery and to orient the battery in a way to position the output port in the direction of the battery eyelet;
one or more device pockets attached to the jacket and including a closable device pocket opening and a device eyelet configured and dimensioned to pass a cord from inside the device pocket to outside the device pocket; and
a plurality of cord tunnels configured to route and secure a cord.

4. The article of clothing of claim 3, wherein the device eyelet is positioned to open between the device pocket and the interior body cavity of the jacket.

5. The article of clothing of claim 4, wherein the device pocket opening opens to the exterior of the jacket.

6. The article of clothing of claim 4, wherein the device pocket opening opens to the interior body cavity of the jacket.

7. The article of clothing of claim 6, wherein the pocket includes a second device pocket opening that opens to the exterior of the jacket.

8. The article of clothing of claim 3, further comprising a wireless media controller including a plurality of buttons, the wireless media controller being configured to send a wireless instruction to an electronic device in response to activation of a button.

9. The article of clothing of claim 8, wherein the wireless media controller is bonded to the outer surface of the jacket.

10. The article of clothing of claim 8, wherein the wireless media controller is bonded to the outer surface of one of the sleeves.

11. The article of clothing of claim 3, wherein the plurality of cord tunnels are connected to the inner surface of the jacket.

12. The article of clothing of claim 11, wherein one or more of the cord tunnels are configured and positioned to route and secure a cord between the battery eyelet and the device eyelet.

13. The article of clothing of claim 12, wherein one or more of the cord tunnels are secured to the inner surface of the jacket adjacent the waist opening.

14. The article of clothing of claim 11, wherein one or more of the cord tunnels are configured and positioned to route and secure a headphone cord between one of the device eyelets and the neck opening.

15. The article of clothing of claim 14, further comprising a magnetic closure configured to hold a headphone or earbud in place near the neck opening.

16. The article of clothing of claim 3, further comprising a detachable internal liner.

17. The article of clothing of claim 16, wherein:
the jacket further comprises a first jacket zipper, a second jacket zipper, and an access panel located between the first jacket zipper and the second jacket zipper, at least some of the cord tunnels are positioned along the access panel, the jacket being configured to be closed by the first jacket zipper;
the internal liner further comprises a liner zipper, the internal liner being configured to be closed by the liner zipper; and
wherein the internal liner is configured to be attached to the jacket by zipping the second jacket zipper to the liner zipper.

18. The article of clothing of claim 17, wherein the internal liner further comprises at least one liner eyelet configured to allow a cord to pass through the internal liner, the at least one liner eyelet corresponding in position to a device eyelet or battery eyelet when the internal liner is attached to the jacket.

19. An article of clothing comprising:
a jacket configured to form an interior body cavity around a user when worn, the jacket comprising:
a first jacket zipper, the jacket being configured to be closed by the first jacket zipper;
a second jacket zipper;
an access panel located between the first jacket zipper and the second jacket zipper;
a neck opening, a waist opening, and sleeves all connected to the interior body cavity;
one or more device pockets attached to the jacket and including a closable pocket opening and a device eyelet configured and dimensioned to pass a cord from inside the device pocket to the interior body cavity of the jacket outside of the device pocket;
a plurality of cord tunnels positioned along the access panel and configured to route and secure a cord; and
a wireless media controller bonded to one of the sleeves and including a plurality of buttons, the wireless media controller being configured to send a wireless instruction to an electronic device in response to activation of a button; and
a detachable internal liner comprising:
a liner zipper;
wherein the detachable internal liner is configured to be closed by the liner zipper;
wherein the detachable internal liner is further configured to be attached to the jacket by zipping the second jacket zipper to the liner zipper; and
at least one liner eyelet configured to allow a cord to pass through the internal liner and corresponding in position to a device eyelet or battery eyelet when the internal liner is attached to the jacket.
